(19) United States
(12) Patent Application Publication
(10) Pub. No.: US 2016/0378291 A1
(43) Pub. Date: Dec. 29, 2016

(54) OBJECT GROUP PROCESSING AND SELECTION GESTURES FOR GROUPING OBJECTS IN A COLLABORATION SYSTEM

(71) Applicant: Haworth, Inc., Holland, MI (US)

(72) Inventor: ROMAIN POKRZYWKA, SAN CARLOS, CA (US)

(73) Assignee: Haworth, Inc., Holland, MI (US)

(21) Appl. No.: 15/093,664

(22) Filed: Apr. 7, 2016

Related U.S. Application Data
(60) Provisional application No. 62/185,501, filed on Jun. 26, 2015.

(51) Int. Cl. G06F 3/0488; H04L 29/08; G06F 3/0484

(52) U.S. Cl. CPC G06F 3/0488; G06F 3/04842; H04L 67/1046; H04L 67/1048

(57) ABSTRACT

A collaboration system can be configured to support a large number of active clients in a workspace where the workspace is distributed into diverse groups of objects. While participating in the workspace, a first active client can consolidate a plurality of objects into a group. Actions taken on this group maintain the proportions and relative positions of the objects within the group. These actions are distributed to a second active client in the workspace wherein the second active client applies these actions to their copies of the objects thereby synchronizing the viewports of the first and second active clients. Actions on a group of objects include resizing, moving, pinning, deleting, and duplicating the group as a whole.

### RELATED APPLICATIONS

Benefit of U.S. Application No. 62/185,501, entitled “Multi-Touch Selection Gestures,” filed 26 Jun. 2015 (Attorney Docket No. HAWT 1020-1) is claimed.

Co-pending, commonly owned, U.S. patent application Ser. No. 14/090,830, entitled “Collaboration System Including A Spatial Event Map,” filed 26 Nov. 2013 (Attorney Docket No. HAWT 1011-2). is incorporated by reference as if fully set forth herein.

### FIELD OF THE TECHNOLOGY DISCLOSED

The technology disclosed relates to methods and systems for digital collaboration, and more particularly to digital display systems that facilitate multiple simultaneous users having tools to group objects in global workspace and control operations for grouping usable in such systems.

### DESCRIPTION OF RELATED ART

Digital displays, usually with touch screen overlays, can be used in a manner analogous to whiteboards. In some systems, such displays are networked and can be used for collaboration, so that modifications made to the display image on one display are replicated on another display. Collaboration systems can be configured to operate collaboration sessions in which users located at different client platforms share a workspace as described in our co-pending U.S. application Ser. No. 14/090,830, entitled “Collaboration System Including A Spatial Event Map,” filed 26 Nov. 2013. The distributed nature of such systems allows multiple users in different places to interact with and change data in the same workspace at the same time, and also at times when no other user is observing the workspace.

### SUMMARY

A system and method for the selection and management of groups of graphical constructs within a collaboration session, and within a distributed network of participants in the collaboration session are described. For example, a system and a method are disclosed, by which a user at one client platform can group objects in the workspace for the purposes of moving, re-sizing, editing, deleting, duplication and other types of manipulation of the objects using group rules, while communicating with users at other platforms in effective ways.

A system described herein includes a network node including a display having a physical display space, a user input device, a processor and a communication port. The network node can be configured with logic to establish communication with one or more other network nodes, and to store for a collaboration session, all or part of a spatial event log of events relating to graphical targets having locations in a virtual workspace allocated for the session. Entries in the log include a location in the virtual workspace of the graphical target of an event, a time of the event, an action relating to the graphical target, and a target identifier of the graphical target. The system can map a screen space in the physical display space to a mapped area within the virtual workspace. The technology disclosed can identify entries in the spatial event log within the mapped area, and render graphical targets identified by the identified entries onto the screen space.

The system can accept input data from the user input device at a network node creating events that identify a group of graphical targets on the local screen space. Group selection events can include gestures executed using a touch screen or other input sensor, such as examples described herein like a two-finger lasso, a four-finger lasso, a string lasso, a zip lasso, and a selection mode selection.

The system can send messages including notifying recipients of the group selection event, and identifying graphical targets as members of the identified group to the one or more other network nodes in the session. The system can also send messages identifying events such as group manipulation or management events which occur for an identified group.

The receiving network nodes of the messages can add the events to the instances of the spatial event map of the session used at their respective network nodes. If the events relate to a graphical target within the screen space of the recipient, then recipient can detect that and render the effects of the event in its screen space. Using the technology described herein, many nodes in a collaboration session can interact with group functions in near real-time.

The client-side node can apply group rules for creating a group of objects by a collaborator accepting input data from the user input device creating events that identify a group of graphical targets on the screen space and sending messages identifying members of the identified group to the one or more other network nodes.

The group rules can include sending messages identifying changes in the members of the identified group.

The group rules can include interpreting an input as a gesture indicating movement of a graphical target within the identified group, and for each member of the identified group moving the identified member in the screen space, and sending a message indicating movement of the identified member to the one or more other network nodes.

The group rules can include interpreting an input as a gesture indicating resizing of a graphical target within the identified group, and for each member of the identified group resizing the identified member in the screen space, and sending messages indicating resizing of the identified member to the one or more other network nodes.

The group rules can include interpreting an input as a gesture indicating deletion of a graphical target within the identified group, and for each member of the identified group deleting the identified member in the screen space, and sending messages indicating deletion of the identified member to the one or more other network nodes.

Other logical rules applied in group processing can include interpreting an input as a gesture indicating removal of a graphical target within the identified group, removing the identified graphical target from the identified group, and sending messages indicating removal of the identified graphical target to the one or more other network nodes.

Other logical rules applied in group processing can include interpreting an input as a gesture indicating addition of a graphical target to the identified group, adding the identified target to the identified group and sending messages indicating addition of the identified graphical target to the one or more other network nodes.

The group rules can include interpreting an input as a gesture indicating duplication of a graphical target within the identified group, and for each member of the identified group duplicating the member of the identified group, and sending messages indicating duplication of the member to the one or more other network nodes.

The group rules can include interpreting an input as a gesture indicating an ungrouping of an identified group, and for each member of the identified group removing the member from the identified group, and sending messages indicating removal of the member to the one or more other network nodes.

A group selection gesture is described, which is called herein a “four-finger lasso.” The four-finger lasso gesture is used to define a region within a screen space that surrounds or intersects a selected group of graphical targets that are rendered on a physical display. In one implementation, four points on a screen that can be touched using two fingers on a first hand and two fingers on a second hand in contact with a touch-sensitive physical display at the same time are used to define a rectangle or other polygon, within which the graphical targets are added to a group.

The above summary is provided in order to provide a basic understanding of some aspects of the collaboration system described herein. This summary is not intended to identify key or critical elements of the technology disclosed or to delineate a scope of the technology disclosed.

### BRIEF DESCRIPTION OF THE DRAWINGS

The technology disclosed will be described with respect to specific embodiments thereof, and reference will be made to the drawings, which are not drawn to scale, and in which:

FIG. 1 illustrates a system of network nodes that collaborate within a collaborative workspace.

FIG. 2 illustrates a portion of an unbounded workspace rendered on a physical screen space.

FIGS. 3A, 3B, 3C, 3D, and 3E illustrate stages in the creation of a group.

FIG. 4 illustrates a flowchart of a group creation.

FIG. 5A illustrates an example where there are five touch points on a screen space.

FIG. 5B illustrates an example where there are six touch points on a screen space.

FIG. 5C illustrates an example where touch points do not precisely comply with a configurable formation.

FIGS. 6A, 6B, and 6C illustrate a single touch group creation.

FIGS. 7A and 7B illustrate stages in a two-finger lasso group selection sequence.

FIGS. 8A and 8B illustrate stages in a sequence for duplication of a group.

FIGS. 9A and 9B illustrate stages in the creation of a group with a circle lasso.

FIGS. 10A, 10B, and 10C illustrate stages in the creation of a group with a swipe lasso.

FIG. 11 illustrates example aspects of a digital display collaboration environment.

FIG. 12 illustrates additional example aspects of a digital display collaboration environment.

FIGS. 13A, 13B, 13C, 13D, 13E, and 13F are simplified diagrams of data structures for parts of the workspace data for a workspace.

FIG. 14 is a simplified block diagram of the computer system 1210, e.g. a client-side node computer system.

FIG. 15 is a simplified flow chart showing logic for handling group related events received at a client-side node from other nodes.

FIG. 16 is a simplified flow chart showing logic for handling group related events received at a client-side node from local user input.

### DETAILED DESCRIPTION

The following description is presented to enable any person skilled in the art to make and use the technology disclosed, and is provided in the context of a particular application and its requirements. Various modifications to the disclosed embodiments will be readily apparent to those skilled in the art, and the general principles defined herein may be applied to other embodiments and applications without departing from the spirit and scope of the technology disclosed. Thus, the technology disclosed is not intended to be limited to the embodiments shown, but is to be accorded the widest scope consistent with the principles and features disclosed herein.

The “unlimited workspace” problem includes the need to track how people and devices interact with the workspace over time. In order to solve this core problem, a Spatial Event Map, and a system architecture supporting collaboration using a plurality of spatial event maps and a plurality of collaboration groups has been described in our co-pending U.S. application Ser. No. 14/090,830, entitled “Collaboration System Including A Spatial Event Map,” filed 26 Nov. 2013, which is incorporated by reference as if fully set forth herein. The Spatial Event Map contains information needed to define targets and events in a workspace. It is useful to consider the technology from the point of view of space, events, maps of events in the space, and access to the space by multiple users, including multiple simultaneous users.

Space: In order to support an unlimited amount of spatial information for a given collaboration session, we provide a way to organize a virtual space termed the workspace, which can for example be characterized by a two-dimensional Cartesian plane with essentially unlimited extent in one or both of the dimensions for example, in such a way that new content can be added to the space, that content can be arranged and rearranged in the space, that a user can navigate from one part of the space to another, and that a user can easily find needed things in the space when required.

Events: Interactions with the workspace are handled as events. People, via tangible user interface devices and systems, can interact with the workspace. Events have data that can define or point to a target graphical construct to be displayed on a physical display, and an action as creation, modification, movement within the workspace and deletion of a target graphical construct, and metadata associated with them. Metadata can include information such as originator, date, time, location in the workspace, event type, security information, and other metadata.

Tracking events in a workspace enables the system to not only present the spatial events in a workspace in its current state, but to share it with multiple users on multiple displays, to share relevant external information that may pertain to the content, and understand how the spatial data evolves over time. Also, the spatial event map can have a reasonable size in terms of the amount of data needed, while also defining an unbounded workspace.

There can be several different kinds of events in the system. Events can be classified as persistent events, also referred to as history events, that are stored permanently or for a length of time required by the system for maintaining a workspace during its useful life. Events can be classified as ephemeral events that are useful or of interest for only a short time and shared live among other clients involved in the session. Persistent events may include history events stored in an undo/playback event stream, which event stream can be the same as or derived from the spatial event map of a session. Ephemeral events may include events not stored in an undo/playback event stream for the system. A spatial event map, or maps, can be used by a collaboration system to track the times and locations in the workspace in some embodiments of both persistent and ephemeral events on workspaces in the system.

Map: A map of events in the workspace can include the sum total of discrete spatial events. When the persistent spatial events for a workspace are available, then that workspace can be “mapped” to a display or screen at a client node that has screen space, where screen space as used herein refers to a displayable area of specific physical size on a screen, which can be mapped to a location (and zoom level) or area in the virtual workspace. Graphical objects located in the mapped area of the virtual workspace are to be displayed in the displayable area at the client node.

Multi-User Access: One key characteristic is that all users, or multiple users who are working on a workspace simultaneously, should be able to see the interactions of the other users in a near-real-time way. The spatial event map allows users having displays at different physical locations to experience near-real-time events, including both persistent and ephemeral events, within their respective displayable areas, for all users on any given workspace.

User manipulation of groups of graphical targets, referred to as group interactions, at client nodes, such as group creation, duplication, movement, editing, group membership modifications, deletion and other group management interactions, can be experienced as near-real-time events, including both persistent and ephemeral events, within their respective screen spaces, for all users on any given workspace.

Widget: A widget is a graphical target included as a component of a workspace that the user can interact with or view in a screen space, e.g. Notes, Images, Clocks, Web Browsers, Video Players, Location Markers, etc. A Window is a widget that is a rectangular region with two diagonally opposite corners. Most widgets are also windows.

A collaboration system as described can be based on a spatial event map, which includes entries that locate events in a workspace. The spatial event map can include a log of events, where entries in the log have the location of the graphical target of the event in the workspace and a time. Also, entries in the log can include a parameter (e.g. url or actual file) identifying graphical constructs used to render the graphical target on a display. A graphical construct has a location and a dimension in the screen space when it is rendered. Server-side network nodes and client-side network nodes are described which interact to form a collaboration system by which the spatial event map can be made accessible to authorized clients, and clients can utilize the spatial event map to render local display areas, and create events that can be added to the spatial event map and shared with other clients.

The workspace associated with a specific collaboration session can be represented as an unbounded virtual area providing a frame of reference without a specified boundary, within which to locate events in time and in virtual collaboration space. The workspace can encompass a virtual area that is practically unlimited in that it has a size large enough that the likelihood of a client-side network node navigating beyond its boundaries is negligible. For example, a size encompassing a virtual area that maps to a physical display space including 1,000,000 pixels by 1,000,000 pixels can be considered practically unlimited in some settings. In some examples, the workspace is essentially “infinite” in that its size is only limited by the extent of the addressing scheme used to identify locations within the virtual space. Also, the system can include a number of workspaces, where each workspace can be configured individually for access by a single user or by a user group.

The collaboration system can be configured according to an application program interface API so that the server-side network nodes and the client-side network nodes can communicate about collaboration events. Messages can be defined that identify events that create or modify a graphical target having a location in the workspace and the time, and groups of graphical targets. The events can be classified as history events and as ephemeral, or volatile events, where history events are stored in the spatial event map, and ephemeral events are not permanently stored with the spatial event map but are distributed among other clients of the collaboration session.

Messages containing collaboration system operating information can be exchanged in for example an application layer including history events and ephemeral events among nodes within the collaboration system.

A collaboration system can have many, distributed client nodes with displays used both to display images based on workspace data managed by a shared collaboration server, and to accept user input that can contribute to the workspace data, while enabling each display to rapidly construct an image to display based on session history, real time local input and real-time input from other client nodes.

The technology described herein may be used to implement a system and method for using touch gestures to select a plurality of objects to be grouped together and treated as a single object. A gesture comprises one or more touch points on a physical display space, where the touch point can include a motion, and where sensors at the physical display space generate data indicating the location of each touch point over time. The generated data indicates a user touch input. The gestures can include several different simultaneous touch gestures. Once objects are selected and grouped, various actions may be taken that have an effect on the selected objects (e.g. copy, delete, resize, move). When objects are grouped they can be treated as a single object (i.e. if one of the objects is selected the group is selected). This group object is a global event and has an effect on the global collaboration.

In embodiments, a computer system receives user touch inputs indicating objects to be included in a group. Selection mode may be initiated by detecting a user touch input. The user touch input may be a predefined touch type and/or gesture associated with initiating a selection mode. For example, a user touch input may be detected on a first object. This user touch input may both initiate a group selection mode and add the first object to a newly created group. This user touch input may be a two-finger tap on the first object in a workspace. In embodiments, the selection mode may be initiated with other gestures, or may be initiated via a button found on a toolbar.

While in the selection mode, user touch input may be received indicating the addition of additional objects into the group. The user touch input may include a user touch input of a tap on each of the additional objects. In embodiments, the user touch input indicating the additional objects may be a continuous swipe from the first object over each additional object to be added to the group. In embodiments, the user touch input indicating the additional objects may be a rectangle drawn by user touch inputs indicating the corners of the rectangle, wherein objects within the box are selected to be included in the group. In embodiments, the user touch input indicating the additional objects may be a user touch input drawing an enclosed shape around the objects to include in the group.

In embodiments, during the selection mode the system can display a visual indication of the objects that are selected to be in the group. For example, the selected objects may be temporarily displayed with a changed shade, tone, or hue during the selection mode. Further, an indication such as a rectangle can be displayed around the selected objects. Unselected objects can be present within the rectangle and can have a visual indication to distinguish the unselected objects from the selected objects, for example the unselected objects can retain their original shade and the selected items can appear faded.

During the group selection mode, a toolbar associated with the group can be displayed. The toolbar can include buttons allowing a user to initiate functions to the group. Example functions can include, create group, move group, resize group, delete group, select additional objects as part of a group, and ungroup selected objects. Once grouped, the objects in the group and functions performed to the group will be performed on each object of the group. Further, because a group is treated as an object, the group can be added as an object in another group. Further, because a group is treated as an object, the location of the group in the collaboration space will be stored in a similar way as an object in the collaboration space.

In embodiments, when an object in a group is selected, the group is selected and actions can be applied to the group. Further, in embodiments, a user may select an object in a group to remove the object from the group while the rest of the objects in the group remain grouped.

### Four-Finger Lasso

The four-finger lasso gesture is used to select objects within a workspace that are rendered on a physical display. In one implementation, a set of touch points is detected, arranged such that the set could be made when two fingers on a first hand and two fingers on a second hand are in contact with a touch-sensitive physical display of an active client at the same time. This event can initiate a group selection mode, and upon a signal indicating the end of the selection sequence, such as one of the sensed touch points ending (e.g., when a finger is removed from the screen), the objects within the rectangle created by the four fingers are added to a group. A separate gesture indicating a selection mode may not be needed in this case.

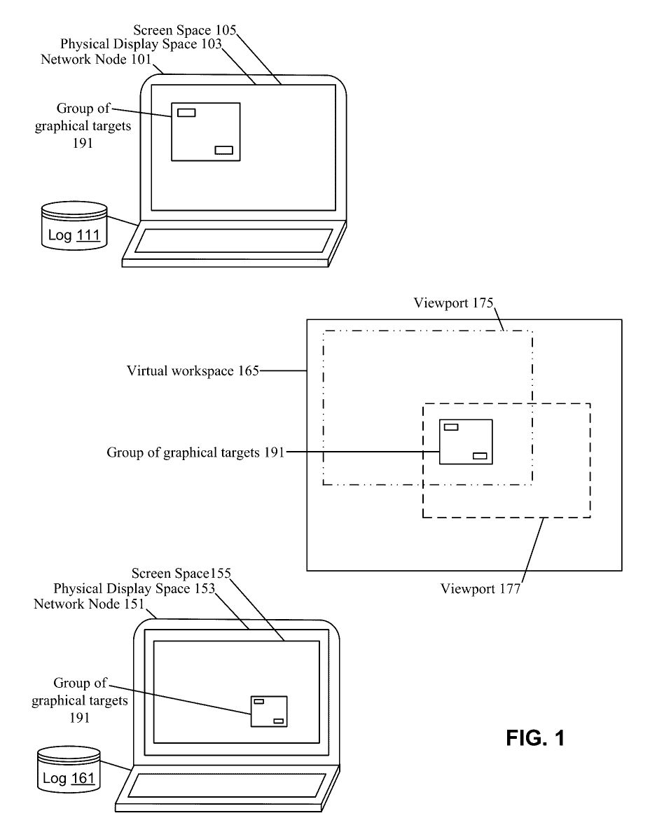

FIG. 1 illustrates a system of network nodes that support collaborative interaction within a collaboration workspace. The illustration shows a first network node 101, a second network node 151 and a portion of a virtual workspace 165. In the illustrated example, the first network node 101 contains a screen space 105, with touch sensors that can perform as a user input device, and a log file 111 that can store event records defining a spatial event map or other type of data structure representing contents of a virtual workspace. The second network node 151 contains a screen space 155, with touch sensors that can also perform as a user input device, and a log file 161 that can store event records defining a spatial event map. The spatial event map can identify contents of a virtual workspace 165, which in this example contains a group 191 of two graphical targets, where the group of graphical targets can be indicated by a border or otherwise on a screen.

The first network node 101 displays objects within a viewport 177 into the virtual workspace 165 that is rendered within the screen space 105 within the physical display space 103. In this example, the screen space 105 includes the entire displayable area of, and has the same resolution as, the physical display space 103. The area identified by the coordinates of the opposing corners of the viewport 177 within the virtual workspace includes the coordinates of the group of graphical targets 191, which are rendered within the screen space 105. The second network node 151 comprises a viewport 175 (overlapping with but different than the viewport 177) into the virtual workspace 165 that is rendered within the screen space 155 defined within the physical display space 153. In this example, the screen space 155 is a window in the physical display space, and smaller than the entire display space, and may have a different resolution than the screen space on the physical display space 153. The area identified by the coordinates of the opposing corners of the viewport 175 within the virtual workspace includes the coordinates of the group of graphical targets 191, which are rendered within the screen space 155.

In one implementation, a gesture such as a four-finger lasso can generate events that identify a plurality of graphical constructs, wherein the identities of the graphical constructs are joined into a group. In one implementation, a network node 101 can recognize events that indicate a group of graphical targets 191. In this implementation, a first network node 101 can send messages to other network nodes participating in the virtual workspace 165 such as a second network node 151. Messages can be generated by, and sent from the first network node 101 to the second network node 151 indicating each touch point, so that the second network node 151 can render an indicator of the touch points. Messages can also include messages that identify potential group members on the first network node 101, which are sent to the second network node 151 so that the second network node can render an indicator of the potential group members. In one implementation, once a selection-end event occurs, such as lifting a finger from a touch point, the technology disclosed includes a module that performs logic to calculate the identity of the graphical constructs within the polygon created by the touch points, and messages that identify a historic event are sent and the event is recorded. The historic event is then sent to other network nodes participating in the virtual workspace 165, and is stored in the spatial event map.

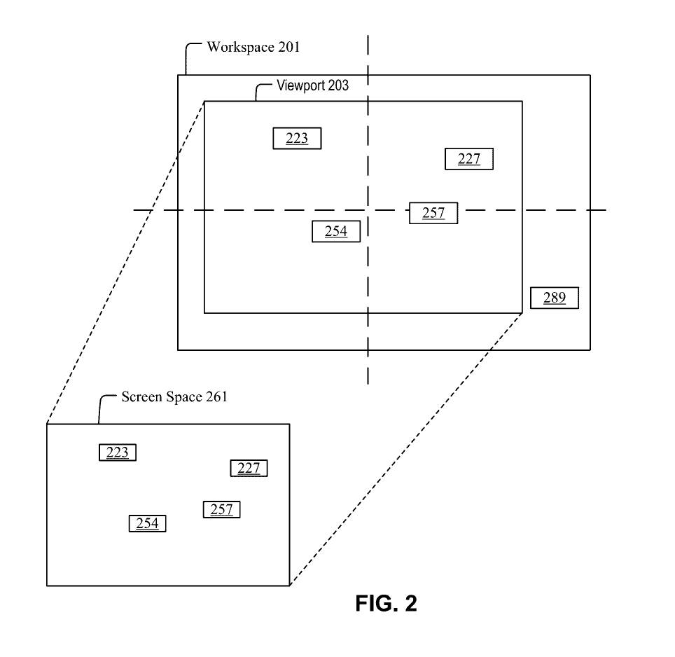

### FIG. 2

FIG. 2 illustrates a portion of a workspace rendered on a screen space. The virtual workspace 201 can comprise a plurality of graphical constructs known as objects 223, 227, 254, 257, 289, which can be graphical targets of events, with each object having a coordinate within the workspace. The physical display space of a client-side network node can be a touch-sensitive display, with a display resolution comprising a number of distinct pixels in each dimension of width and height. A screen space 261 is a region on the display having x, y coordinates that can be a window on the display, or the whole display where the x, y coordinates of the screen space equal the dimensions of the physical display. The screen space 261 gets rendered by a display client on the physical display. The local display client can have a touch screen that overlies the screen space, which is used as a user input device to create events. The local display client can also have other input devices such as a mouse. A mapped area, also known as a viewport 203, within the virtual workspace 201 is rendered on a physical screen space 261. A viewport is a polygon that can be defined by an x, y coordinate for its center, and a z coordinate indicating a zoom level into the workspace. A viewport can also be defined by two opposing corners have coordinates within the virtual workspace 201. The coordinates of the viewport 203 are mapped to the coordinates of the screen space 261. In one example, the objects 223, 227, 254, 257 within the viewport 203 are rendered on the screen space 261. The coordinates in the workspace of the viewport 203 can be changed, which can change the objects contained within the viewport, and where the change would be rendered on the screen space 261. The zoom level, or z level, of the viewport 203 can be increased to include a larger portion of the workspace 201, or decreased to include a smaller portion of the workspace. The change in zoom level would also be rendered on the screen space 261. In another implementation, the coordinates of a corner of a viewport 203 can be changed, which can change the objects contained within the workspace, and where the change would be rendered on the screen space 261.

Objects 223, 227, 254, 257, 289 can be moved to coordinates that are within the boundaries of a viewport 203, or outside of the boundaries of the viewport. FIG. 2 illustrates five objects 223, 227, 254, 257, 289 in a portion of the workspace, and a viewport 203 that surrounds four of the five objects, where the four objects 223, 227, 254, 257 are rendered on the screen space 261.

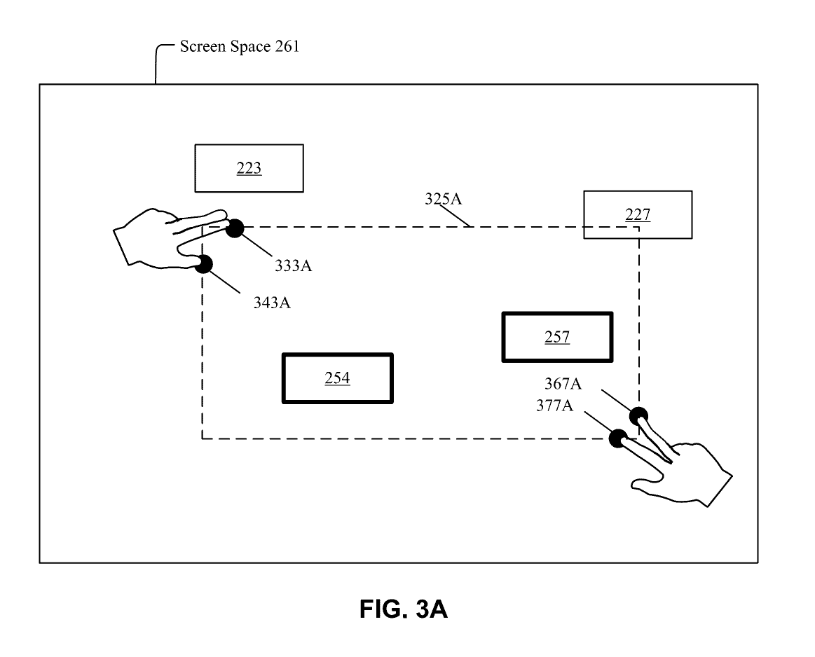

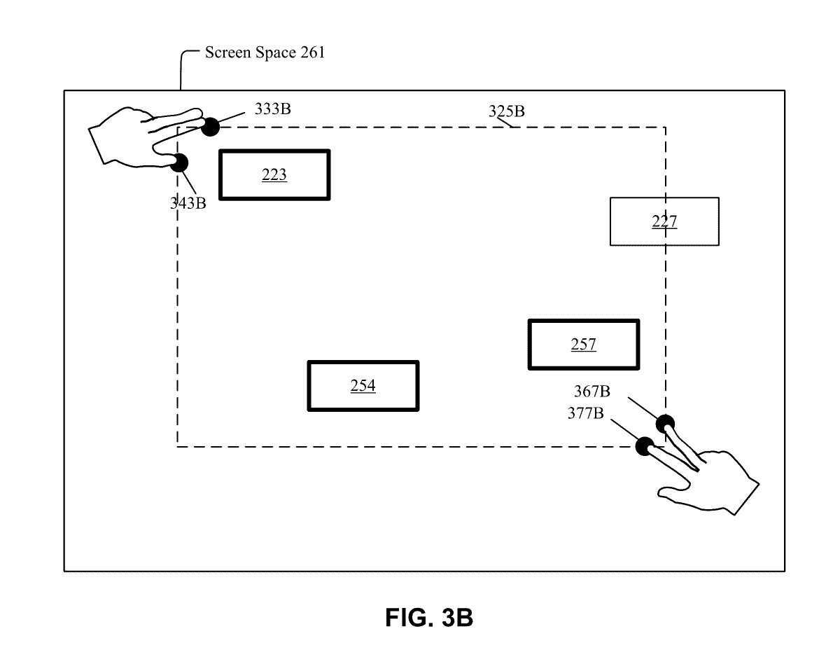

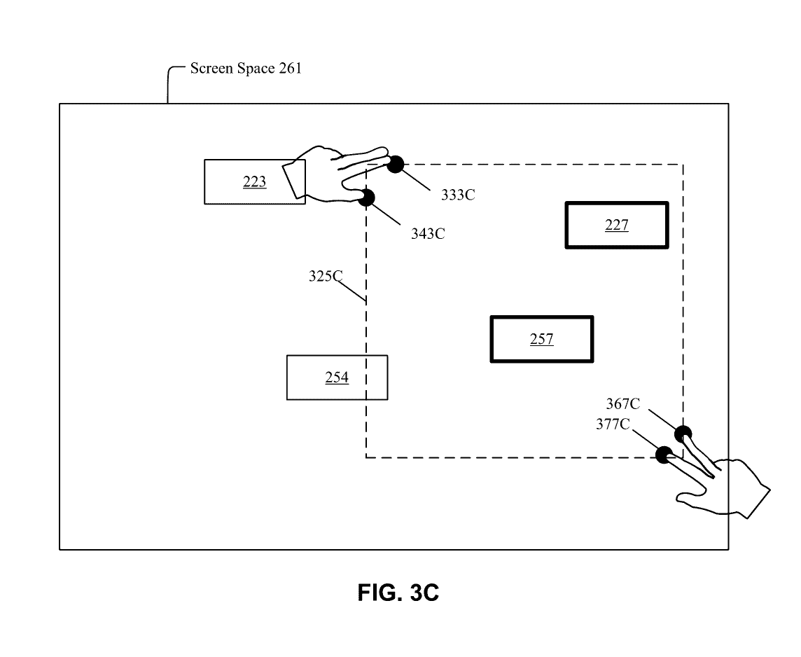

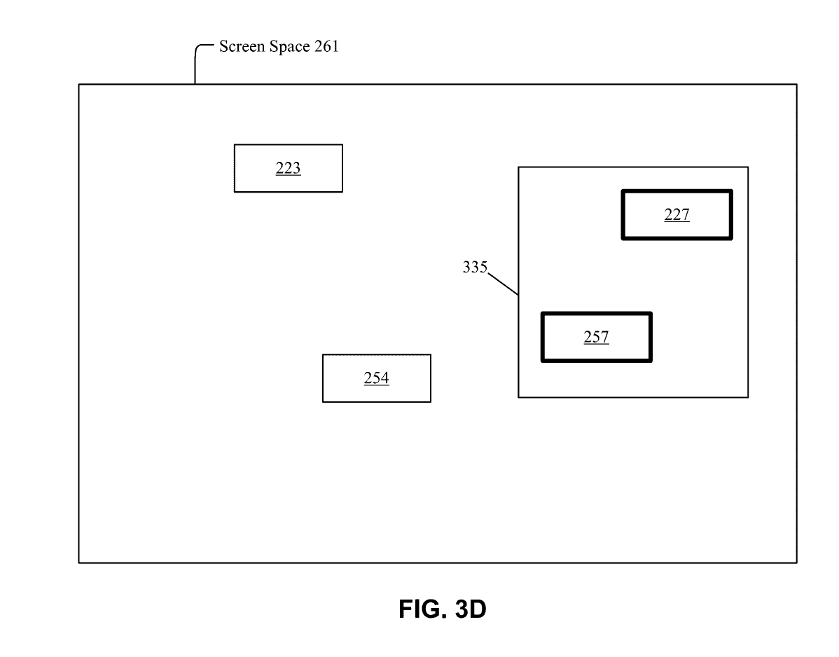

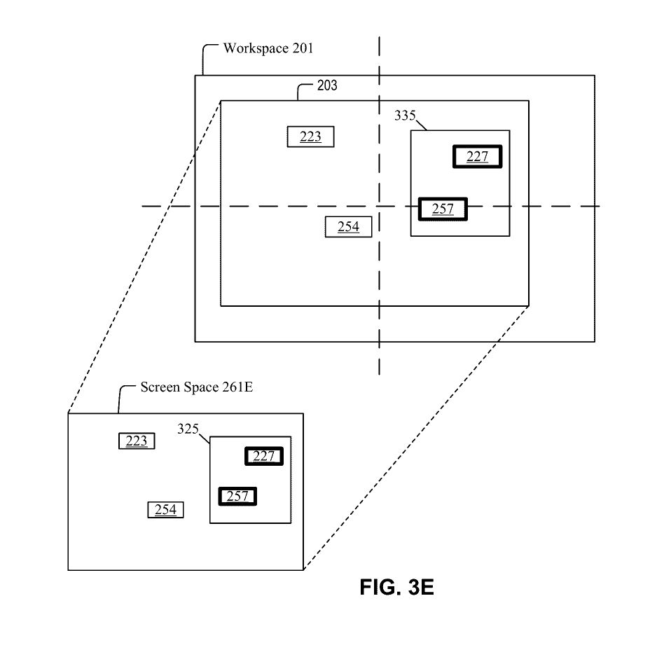

### FIGS. 3A-3E

FIGS. 3A, 3B, 3C, 3D, and 3E illustrate stages in the creation of a group using a four-finger lasso.

FIG. 3A illustrates the screen space 261 with rendered objects 223, 227, 254, 257. Also illustrated are four touch events comprising two touch points 333A, 343A which can be made by a first hand on the screen space 261, and two touch points 367A, 377A which can be made by a second hand on the screen space. In this example, the highest touch point 333A is determined to be the topmost portion of the rectangle 325A, the leftmost touch point 343A is determined to be the leftmost portion of the rectangle, the rightmost touch point 367A is determined to be the rightmost portion of the rectangle, and the bottommost touch point 377A is determined to be the bottommost portion of the rectangle. Other types of polygons other than rectangles can be used. The four-finger lasso gesture is illustrated as a sequence of screen space renderings as shown in FIGS. 3B-3E as the touch points are moved during a selection procedure.

Objects surrounded by or intersected by the rectangle can be the graphical targets of a group creation event. In this example, objects 254, 257 that fit completely within the rectangle 325A can be identified and added to a list of objects. In another example, an object that overlaps with the boundary of a rectangle 325A such as object 227 can be identified and added to the list. The display client can indicate the objects by a change in an attribute such as hue or border. In this example, the border of the objects 254, 257 inside the rectangle and added to the list are bolded.

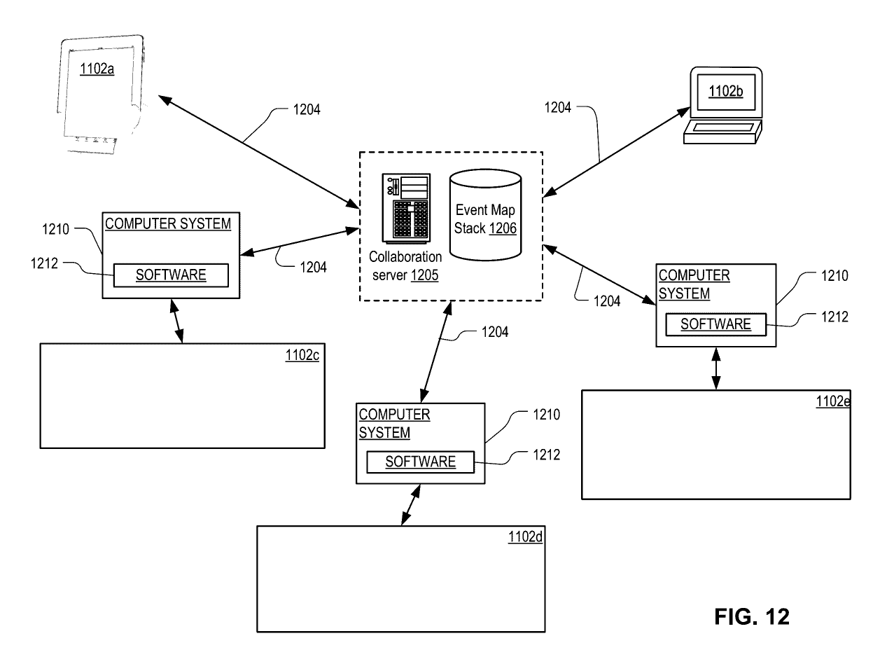

Each touch point can be determined from a touch event that is an action or sequence of actions signaled by the touch-sensitive display that is stored in a local log. In some embodiments, the event can also be communicated to one or more other network nodes. The current example has four simultaneous touch events creating four touch points where the touch points are grouped in pairs by proximity to each other. On a network node, such as one supporting the display 1102c of FIG. 12, a number of touch events can occur at any time. The technology disclosed can create an ephemeral, or volatile, event for each touch point, and communicate the ephemeral event to other network nodes. When four touch points are detected with the group selection configuration, the local node executes logic to identify a polygon on the screen, and display an indication of its boundary. In the case of the four-finger lasso gesture is when one of the fingers is lifted, at that point a group create event created by the local node, and is sent with a list of the objects that were in the area delimited by the polygon represented by the four fingers at the time the finger was lifted. Other clients may not produce the indicator of the polygon created as the touch points from the fingers are moved on the display, either because interim touch events are not broadcast before the group create event or because the other clients are programmed to delay rendering an indicator until the group create event is received. By deferring the group create event messages until the gesture is completed by removal of one or more of the touches, there are no ‘live’ selection state changes for the objects in the session as finger touches move to include more objects.

In this example, the event-type can be a code which indicates the beginning of a new stroke of a gesture that is part of a group selection gesture. As a touch point is moved across a touch-sensitive display, a “ve” record can be created with an event-type of another code, which indicates a continuation of a previously started stoke. An end event, such as when a stroke has ended, can generate a “ve” record with an event-type indicating an end of the stroke. The sequence of “ve” records are sent to other network nodes where each receiving network node can render the graphical constructs associated with each group selection event (border rendering, highlighting and so on). Completion of a group selection event can be shared using an “he” (Historic Event) record or a set of historic events.

In one implementation, a touch-sensitive display has a sensor that detects touch events on the screen, and generates data that identifies coordinates sensed for the touch event or events. The sensor or sensors can detect multiple touch events simultaneously, and provide data for all of them. The data from the sensor is processed to identify a coordinate for each event, such as by finding a center point for the data of the event or otherwise.

Logic in the network node executes an algorithm that selects locations of two touch points of the four simultaneous touch events as a first pair, and identifies the other two touch points as a second pair. A network node supporting the physical screen space 261 can calculate a rectangle that would pass through the four touch points 333A, 343A, 367A, 377A, and display the rectangle 325A on the screen space. While the four touch points are still being touched, a visual indicator, such as rectangle 325A, is used to indicate the boundaries of the four-finger lasso. In one implementation, a dotted line indicates the borders of the rectangle 325A. As the user moves the touch points on the screen, the potential group rectangle 325A border moves with the touch points.

For example, at a later time the client renders the screen space as shown in FIG. 3B, illustrating rendering after the two touch points 333B, 343B created by the first hand have been moved, while the two touch points created by the second hand have remained stationary as touch points 367B, 377B. As a result, the object 223 falls within the borders of the rectangle 325B. In this example, the border of object 223 is bolded to indicate its membership within the potential group rectangle 325B.

Touch points can be moved so that objects that were completely within the potential group borders are no longer within the potential group. FIG. 3C illustrates rendering of the screen space after the touch points 333C, 343C of the first hand are moved to a new location on the screen space 261, and the touch points 367C, 377C of the second hand are also moved to a new location on the screen space. In this example, the motion causes the border of potential group rectangle 325C to move so that it intersects with the new locations of the touch points. The new borders of the potential group rectangle 325C no longer fully envelop the objects 223, 254, and the borders of the objects 223, 254 are removed from the list of graphical targets of the gesture, and graphical constructs as rendered can be changes, such as by being un-bolded. The new borders of the potential group rectangle 325C still fully envelop object 257, which continues to have a bolded border. The new borders of the potential group rectangle 325C also fully envelop object 227, which now has a bolded border for an indication.

As a selection-end event occurs, such as the signals indicating a user removing one or more their fingers from the touch points, the network node can identify the group of graphical targets as part of a group. The active client can create a History Event (“he”) record to create a type “group”, which contains the identity of the active client that created the group, and a list of the children within the group, which in this example are objects 227 and 257 of FIG. 3D. The “he” record is stored in a local spatial event log, and also communicated to a spatial event map. The active client supporting the screen space 261E can create a visual indicator of a final group, for example, by a group rectangle 335 surrounding the objects in the group, or a change in shade or hue of the borders of the member objects. The “he” “create” “group” record is defined in the Application Programming Interface (API) included below. The “he” record can be communicated from the network node to one or more other network nodes participating in the workspace.

// client ″-> server
[client″id,
″he″ ,
target-id,
″create″ ,
{″type″ : ″group″,
-id″ : ″S3aS2b392S8f62fce″ ,
-children″ : [array of target IDs of widgets that should be part
of the group]}]

Once the “he” record has been communicated to the another network node, and added to the records defining the workspace, the group 335 within the workspace 201 can be rendered on a screen space 261E of any active client where the viewport of the active client contains the group, as illustrated in FIG. 3E. Group operations at the node which created the group, and at any node which received the messages, can be executed. Once an object has been included in a group, a client node can be designated owner of the group, and it can be for example locked, and while locked only be modified by the owner of the group. In one implementation, a graphical user interface button or other user input construct can be provided at one or more other network nodes so that they can take ownership of a group.

Group manipulation rules can be implemented at each client node. A rule can include logic that allows an object to be part of only one group at a time. Once a group of graphical targets has been created, actions can be applied to it such as resize, copy, move, and delete. In one example, a user can identify the group by touching an object within the group to select the group. Once the group has been selected the user can move the group by touching an object in the group without releasing it, then moving the group across the screen. In this example, movement is in response to a gesture interpreted as an input requiring movement of an object with the group, moving the objects in the group and sending messages to other nodes to move each of the objects. In another implementation, a user can click on an object with a mouse, then grab the object with the mouse and move it. Releasing the mouse button can leave the object in its new location within the workspace 201. During the movement of the group, a “ve” (volatile event) record is created that keeps track of movement in the workspace of the group on a timely basis, which can be every 1/40^{th} of a second. Once the user removes the finger from the screen, the active client no longer generates “ve” records, and then generates a final “he” record indicating the final coordinates of the group. Both the “ve” and “he” records are communicated to all other participants in the workspace. In the example to move a group, the “he” “position” record is created, which identifies amount and direction of movement the groupusing the “rect” component of the “he” “position” record, and the “order” component of the “he” “position” record identifies the zoom level. Group actions are described more fully in the API section below.

// server <-- client
[client-id, ″he″, target-id, ″position″, {″rect″:[−1298,−390,−1018,−230],
″order″:4}]
// server --> client
[client-id, ″he″, target-id, event-id, ″position″, {″rect″:[−1298,
−390,−1018,−230],″order″:4}]

In some embodiments, only the first two components of the “rect” parameter in the “position” he messages are used (x and y) and they represent the amount of movement relative to the group's position when created. So for a group of objects created anywhere in a workspace, then a drag of that group 10 workspace units to the right and ten units to the top, the ‘rect’ component of the resulting position event would be [10, −10, 1, 1]. These movement parameters are associated in the workspace records with the members of the group, and so other nodes receiving the “position” event can apply the move to the members of the group. This approach can to avoid having to send position events on select/deselect events objects which change the border or the membership list of the group. As for the last two numbers (1, 1 in this example), they may be unused or may be used to represent the horizontal and vertical scaling factors compared to the initial group size. So 1 means that the group's size isn't changed. If a pinch-zoom gesture on the group were detected to make it twice as big as initially, the resulting ‘rect’ would then be [10, −10, 2, 2]. Alternatively if a pinch-zoom gesture on the group were detected to make it half the size as initially it would be [10, −10, 0.5, 0.5]. In another alternative, other types of group location parameters can be utilized.

Animations can occur on the display to indicate an action being taken on a group. For example, while moving a group across a screen, the client can render its screen space so that group changes color, shade, or outline. The group animation on a particular node can be locally programmed. In alternative systems, move processes in the workspace can be included in the record of the collaboration, and reported to other nodes by a variation of the following record. In the following example, the “he” “template” record indicates a color setting of beige.

[client-id, “he”, workspace-id, event-id, “template”, {“baseName”: “sessions/all/Beige”}]

Deletion of a group causes an “he” “delete” deletion record to be generated for the group.

[client-id, “he”, target-id, “delete”, {“hidden”:true}]

The ungrouping of a group first causes an “he” “membership” record with the group target-id, but with no children, to be created. Then, an “he” “delete” deletion record can be generated for the group.

[client-id, “he”, target-id, “membership”, {“children”:[ ]}]

[client-id, “he”, target-id, “delete”, {“hidden”:true}]

### Group Create Example

// client ″-> server
[client″id,
″he″ ,
target-id,
″create″ ,
{″type″ : ″group″ ,
-id″ : ″S3aS2b392S8f62fce″,
-children″ : [ ]}]

Props
type (string) “group”
id (string) unique identifier for the group
children (array) array of target-ld's of widgets that should be part of the group

### Generic Group Position Example

//client- ->server
[client-id, he, groupid, ‘position’, {“rect”: [0, 0, 0, 0], “order”:4}]

Props
rect (object) The rect of the group. Specified as x1, y1, x2, y2,
order (int) the z-order of the target group
   membership
   Replaces the target object's children. Used for grouping items.

```
// server <-- client
[client-id, ″he″, target-id, ″membership″, {″children″ :
    [53a52b39250f62fce, 53a52b39250f62fce]}]
// server --> client
[client-id, ″he″, target-id, event-id, ″membership″, {″children″ :
    [53a52b39250f62fce, 53a52b39250f62fce]}]
```

Properties
children (array) Required. An array containing at least one widget ID to include in the group. To remove all children, a delete message should be used instead.

### Group Document Create Example

// server --> client
[ client-id,
″he″,
target-id, // group document id
event-id,
″create″,
{
″type″: ″document″,
″rect″:[x1,y1,x2,y2]
″maxWidth″:123,
″maxHeight″:456,
″layout″:″stacked″,
″title″:″title of this document″,
″assetURL″: ″xxx/xxx/xxx.docx″,
″hidden″: true,
″pin″: false,
″activeChildId″: ″id1838094221″,
″children″: [
″id0398749123″,
″id1838094221″,
″id2849239042″,
″id3849012830″]}]

Properties
type (string) “groupdocument”
activeChildId (string) active child Id, such as currently displayed page of PDF/Doc
children (array) array of child(page) object IDs, array order represents the child(page) order.
layout (string) Define the client layout to render this group document.

A good example illustrating some of the HistoryEvent/VolatileEvent-related changes is moving a group of objects. While the group is being moved, the client receiving the user input identifies members of the group, and generates a sequence of messages for each identified object. As an object is being moved/resized by dragging a group, a series of volatile events (VEs) is sent to the other network nodes, such as by sending a message to the server, which re-broadcasts the message to all clients subscribed to the workspace:

```
// client sends the following volatile events during the move
// client->server format is: [<clientId>, <messageType>, <targetId>,
        <eventType>, <messageProperties>]
[″511d6d429b4aee0000000003″,″ve″,″511d6f9c9b4aee0000000039″,
″position″,{
  ″rect″:[−493,73,−2,565],
  ″order″:0
}]
[″511d6d429b4aee0000000003″,″ve″,″511d6f9c9b4aee0000000039″,
″position″,{
  ″rect″:[−493,73,−2,565],
  ″order″:0
}]
[″511d6d429b4aee0000000003″,″ve″,″511d6f9c9b4aee0000000039″,
″position″,{
  ″rect″:[−538,91,−47,583],
  ″order″:0
}]
[″511d6d429b4aee0000000003″,″ve″,″511d6f9c9b4aee0000000039″,
″position″,{
  ″rect″:[−538,91,−47,583],
  ″order″:0
}]
```

Once the user finishes moving the group, the client sends a sequence of a history events to specify the location and order of the object:

```
[″511d6d429b4aee0000000003″,″he″,″511d6f9c9b4aee0000000039″,
″position″,{
  ″rect″:[−492,73,−1,565],
  ″order″:0
}]
```

The server will respond with the newly persisted he record. Note the inclusion of the record's eventId.

```
// server-> client format of ‘he’ is: [<clientId>, <messageType>,
// <targetId>, <eventId>, <eventType>, <messageProps>]
[″511d6d429b4aee0000000003″,″he″,″511d6f9c9b4aee0000000039″,
      ″511d9165c422330000000253″,″position″,{
  ″rect″:[−492,73,−1,565],
  ″order″:0
}]
```

Client nodes include logic to download a spatial event map or a portion of the spatial event map, and to parse the spatial event map to compose graphical objects to be displayed in the screen space. Also, in support of group operations, during parsing of the spatial event map, all groups and the members in each group can be identified. A file can be created and stored that lists the identified groups. When receiving messages from other network nodes carrying new events, the graphical targets of the events can be matched with the members of the groups identified in the file. Processing of the event can be modified based on membership of an existing group. When receiving messages such as the membership message described above, the group membership file can be updated along with storing of the event in the local spatial event map.

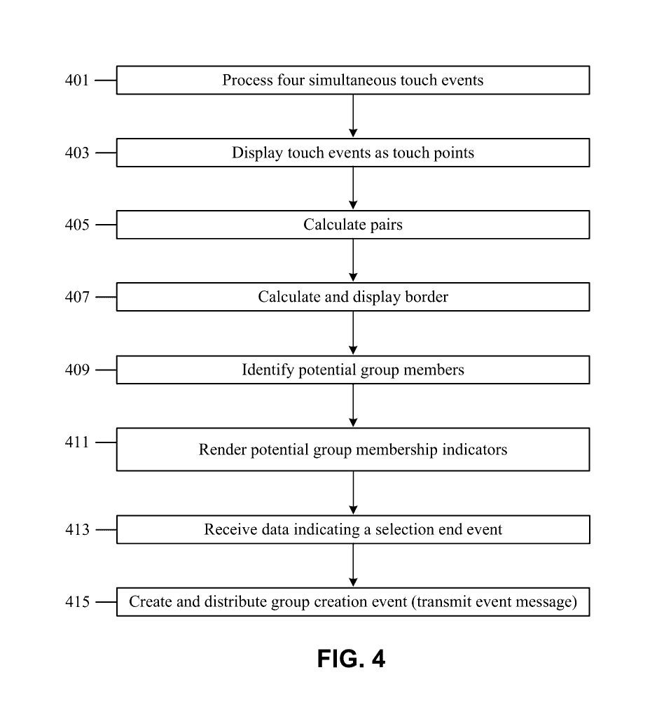

FIG. 4 illustrates a flowchart of a group creation process executed by logic at a network node having a display used to render a screen space, referred to as a client-side network node. In one implementation, a client-side network node can process four simultaneous touch events 401 occurring on a touch-sensitive display. A screen space of a physical display space can display the touch events as touch points 403. In one implementation, a touch point can be indicated by a shape displayed on the screen space. The network node can calculate pairs of touch points 405 based on configurable definitions of touch point pairs. The network node can then calculate and display a potential group border 407 intercepting the four touch points. The client-side network node can identify the objects within the boundaries of the border that are potential group members 409. The identification of potential group members can include objects that rest completely within the potential group border, and can also include objects that overlap with the potential group border. The network node can display indicators on the screen space that indicate the objects that are members of the potential group 411. In one example, the hue, shade, or border of an object can be modified to indicate membership. The network node can receive data indicating that a user is no longer touching all four touch points simultaneously 413, which can cause the network node to create and distribute a record indicating a group creation event 415.

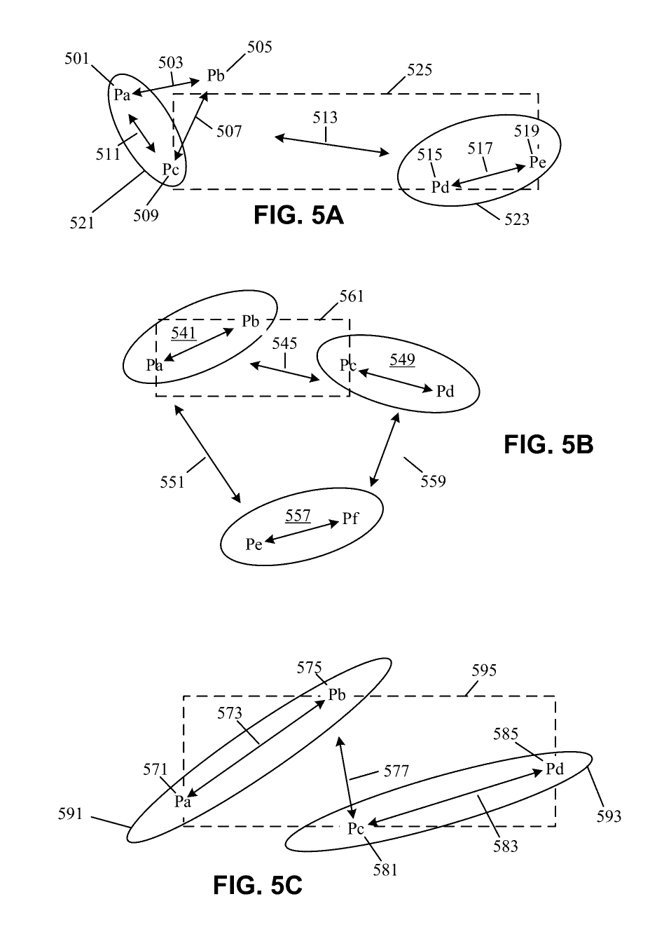

The technology disclosed includes logic to process four simultaneous touch events 401 on a screen space, such as the touch events that occur with the four-finger lasso described in FIGS. 3A-3E. The touch events can be displayed as touch points 403 as shown in FIG. 3A. Optionally, “ve” records are created by the network node of the screen space 261 indicating the touch events. The optional “ve” records are sent to the one or more other network nodes participating in the workspace 201. The technology disclosed includes a module that performs logic to calculate pairs of touch points 405. Grouping pairs of touch points, and the resolution of conflicts, is described in FIG. 5. A border intersecting the touch points can be calculated and displayed 407 on the screen space 261. The border can also be generated by the processing of “ve” records indicating a potential group. The module can also perform logic that identifies potential group members 409. This logic can render potential group membership indicators 411 on the screen space 261, and optionally can send “ve” messages indicating potential group membership to the one or more other network nodes. A receiving of data indicating a selection-end event 413 can generate an “he” group creation record. The “he” record can then be distributed to the one or more other network nodes 415. Upon receipt of an “he” record, a receiving network node can contain logic to modify the border of the identified group from a potential group to a group. The receiving network node can also contain logic to modify the appearance of the members of the group to indicate their membership within the group.

### FIG. 5—Groups and Conflicts

FIGS. 5A, 5B, 5C, illustrate a touch point interpretation process, including conflict resolution between touch events.

A four-finger lasso occurs when four simultaneous touch events can be grouped into two pairs of touch points. Grouping can occur based on a spatial relationship between the touch events. However, when working on a touch-sensitive screen space, a user can create other than four simultaneous touch events, and the spatial relationships may not precisely conform to a configurable formation. FIGS. 5A, 5B, 5C illustrate how conflicts in touch event counts and spatial relationships can be resolved.

A touch event can comprise a plurality of adjacent pixels on a touch-sensitive display. In one implementation, a touch point can be calculated as the approximate center of the adjacent pixels of the touch event. A pair of touch points can include two touch points that are within a first distance parameter, for example 6 inches, of each other on a screen space 261. Two pairs of touch points are considered to be a four-finger lasso if the calculated centers of each pair of touch points are within a second distance parameter, for example two feet, of each other. In one example, there can be an instance where there is other than 4 touch points at a time. For example, a user can touch the surface with one finger of one hand, and two fingers of the other hand, which does not cause any response. A user can touch the surface with three fingers of one hand and two fingers of the other hand, resulting in 5 touch points. In another example, a user can touch the surface with three fingers of each hand, which can result in 6 touch points. In another example, a first touch point on a first hand is closer to a first touch point on a second hand than it is to a second touch point on the first hand. In another example, a first user might select an object for inclusion within a group that has already been included in a different group by a second user.

FIG. 5A illustrates an example where there are five simultaneous touch points on a screen space. FIG. 5A comprises touch points Pa 501, Pb 505, Pc 509 created by a first hand. Also illustrated are touch points Pd 515, and Pe 519 created by a second hand. Distance 503 is the distance between touch points Pa and Pb. Distance 507 is the distance between touch points Pb and Pc. Distance 511 is the distance between touch points Pa and Pc. Distance 517 is the distance between touch points Pd and Pe. A first pair 521 is a pair of touch points Pa 501 and Pc 509. A second pair 523 is a pair of touch points Pd 515 and Pe 519. Distance 513 is the distance between a center (or other location representative of the location) of the first pair 521 and the center (or other location representative of the location) of the second pair 523.

Once the touch-sensitive display receives data indicating at least four simultaneous touch points within the screen space 261, the network node calculates the distance between the touch points. In this example, the touch points Pd 515 and Pe 519 are within a configurable first distance of 6 inches of each other, and touch points Pd 515 and Pe 519 are both greater than the first distance (6 inches) from touch points Pa 501, Pb 505, and Pc 509. In this example, the touch points Pd 515 and Pe 519 would be grouped as a first pair 523.

Touch points Pa 501, Pb 505, and Pc 509 are all within the configurable first distance (6 inches) of each other, and are each greater than the first distance from touch points Pd 515 and Pe 519. These three touch points need to be resolved into one pair of touch points. The distance 511 between Pa 501 and Pc 509 is less than the distance 503 between Pa 501 and Pb 505. Likewise, the distance 507 between Pc 509 and Pb 505 is greater than the distance 511 between Pc 509 and Pa 501. Therefore, the system will choose Pa 501 and Pc 509 as a pair of touch points for a second pair 521. The first pair 523 and the second pair 521 comprise points used to define borders of a polygon 525 for selecting a potential group. The algorithm then calculates and displays the potential group polygon 525 where the borders transect the four touch points Pa 501, Pc 509, Pd 515, Pe 519. In this example, since Pa 501 is above, but to the left of Pc 509, the topmost touch point Pa 501 of the pair 521 becomes the topmost portion of the rectangle identifying the potential group 525, and the leftmost touch point Pc 509 of the pair 521 becomes the leftmost portion of the rectangle.

FIG. 5B illustrates an example where there are six touch points on a screen space. In FIG. 5B, a first pair 541 comprises touch points Pa and Pb, a second pair 549 comprises touch points Pc and Pd, and a third pair 557 comprises touch points Pe and Pf. The distance between the center of the first pair 541 and the center of the second pair 549 is distance 545. The distance between the center of the first pair 541 and the center of the third pair 557 is distance 551. The distance between the center of the second pair 549 and the center of the third pair 557 is distance 559.

In this example, the center of each pair 541, 549, 557 is calculated by the network device, and distances between the centers of the pairs are calculated. In this example, distance 545 is less than distance 551, and distance 545 is less than distance 559. The algorithm of the technology disclosed will chose the two closest pairs comprising the first pair 541 and the second pair 549 as the two pair of touch points to be used to generate a potential group rectangle 561. In this example, touch point Pc of pair 549 is to the left of touch point Pd of pair 549, so Pc becomes the rightmost portion of the potential group rectangle 561, and Pd becomes the lowermost portion of the potential group rectangle 561.

FIG. 5C illustrates an example where touch points do not precisely comply with a configurable formation. In FIG. 5C, touch points Pa 571, Pb 575, Pc 581, Pd 585 are identified. In addition, the distance between Pa 571 and Pb 575 is identified as distance 573. The distance between Pb 575 and Pc 581 is identified as distance 577. A first pair 591 and a second pair 593 are identified. And the distance between Pc 581 and Pd 585 is identified as distance 583. In this example, a first hand creates the touch points Pa 571 and Pb 575, and a second hand creates the touch points Pc 581 and Pd 585. The configurable formation of pairs describes two pairs where the distance between the touch points of a pair are within the first distance 6 inches of each other, and the centers of two pairs are within two feet of each other. This allows for a distance of 6 inches between the fingers of a hand to be used to create one pair. It also allows for a distance of two feet between a left and right hand of a person working on a large format display 1102c. This can also narrow a multi-touch selection gesture to a single user when more than one user, such as users 1101c, and 1101d, is working on a large format display.

When a small group is created, the four touch points can be much closer to each other than six inches. The example in FIG. 5C shows touch point Pb 575 in pair 573 as being closer to touch point Pc 581 in pair 593, than it is to touch point Pa 571 in pair 573. It also shows touch point Pc 581 being closer to touch point Pb 575 than it is to touch point Pd 585. An algorithm to reconcile this arrangement can first record the four touch points, and then calculate the distances between them. The algorithm then identifies that pairing the two closest touch points Pb. 575, Pc 581 will leave two unpaired touch points Pa 571, Pd 585 where their closest touch points are already paired. The algorithm then bars touch points Pb 575 and Pc 581 from pairing, and then re-runs the pairing algorithm. The pairing algorithm then finds available pairs 591 and 593 and pairs the associate touch points, creating a potential group 595.

### Grouping Conflict Between Two Network Nodes

In one example a first and second network node select the same object for inclusion within a group at the same time, where each network node has created an “he” group record, but the first and second network nodes have not yet received the “he” group record from each other. As an object can only be a member of one group, the first client to define the group containing the object in conflict can keep the object within its group. The client that was second in defining its group is responsible for removing the conflicting member by sending an updated “he” “membership” record for its group.

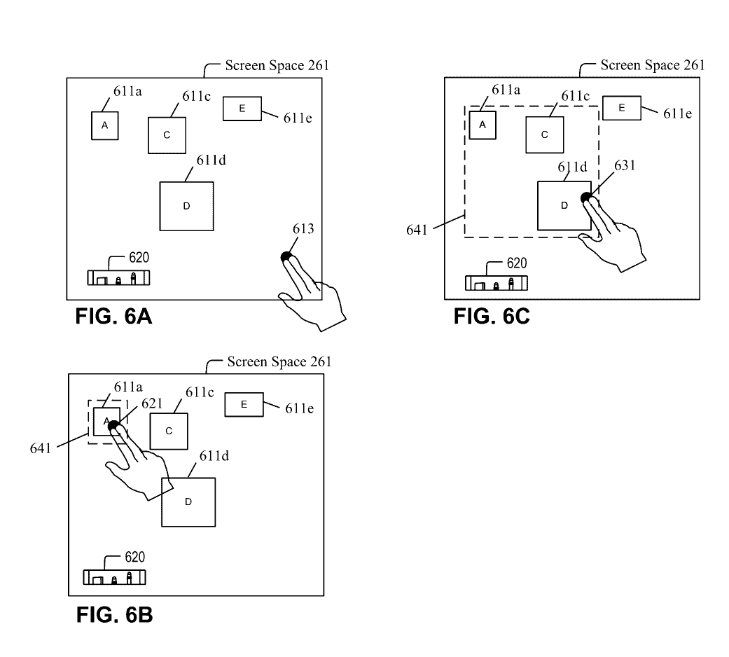

### FIG. 6—Single Touch Group Creation

FIGS. 6A, 6B, and 6C illustrate a single touch group creation. In one implementation a user can enter selection mode via a button on the toolbar. In another implementation, touching an object for a long touch collectively enters selection mode, and creates a group event with one group member, that member being the object being touched. Once a group has been created, group actions such as duplicate the group, move the group, delete the group, ungroup the group, remove objects from the group, add objects to the group, and resize the group can be performed.

FIGS. 6A-6C show a screen space 261, with a toolbar 620 displayed within the screen space. Four graphical constructs 611a, 611c, 611d, and 611e are also identified.

To create a group with a toolbar 620, a selection mode can be initiated by a button on the toolbar. The toolbar can be anywhere on the screen space 261, and can be visible or invisible. When visible, the toolbar can be moved as if it were any other object on the screen space. The “ve” messages created indicating motion of the toolbar can be sent to the one or more other network nodes, where the movement of the toolbar can be rendered on the receiving network node screen space by the receiving network node. A selection-end event can then generate an “he” message, which can also be sent to the one or more other network nodes, and which can be stored in the spatial event map. If the toolbar is not visible, it can be made visible by a long touch on an area of the screen space where there are no objects, such as the canvas. In one example, a long touch can be a touch lasting 2-to-3 seconds without movement, as illustrated by the long touch 613 illustrated in FIG. 6A. A long touch causes a toolbar 620 to be displayed. A button on the toolbar can be assigned an action of toggling into, and out of, a selection mode.

FIG. 6B illustrates the selection of an object 611a as a member of a group 641. In this example, selection mode has been selected with the selection mode button on the toolbar 620. While in selection mode, a touch 621 on object 611a selects object 611a as a member of the group 641. A second touch of the object 611a removes the object from the group. In this example, an “he” record of type “create” “group” is created with one child being object 611a, and the shade of object 611a is darkened to indicate membership in a group.

FIG. 6C illustrates the selection of a second object 611d into the group 641 by a touch 631. In this example, an “he” “membership” record is created that adds the object 611d to the group 641.

// client --> server
[client-id, “he”,“53a52b39250f62fce”, event-id, “membership”,
{“children” :[“53a52b39250f62fca”,”53a52b39250f62fcb”}]

Children can then be added or removed at will during the group lifetime, using a membership message. The “he” “membership” record is communicated to one or more other network nodes, and stored in the local log. The shade of object 611d is darkened to indicate membership in the group. And the group 641 border is extended to envelop the two members of the group 611a, 611d. In this example, objects within the boundaries, or that overlap the boundaries of the group 641 borders, such as object 611c, are not altered, and actions on the group will not affect them. A semi-long touch on the canvas outside of selection area is one method of exiting selection mode. The selection mode button on the toolbar 620 is another method of exiting selection mode.

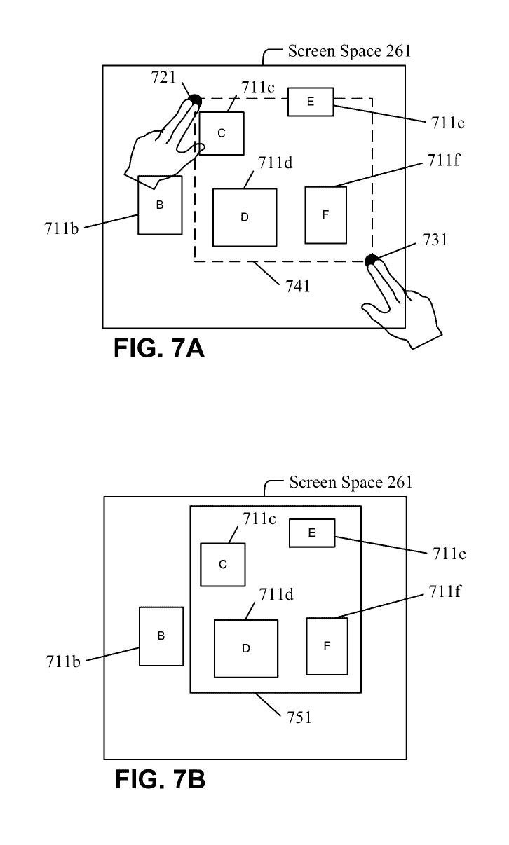

### FIG. 7—Two-Finger Lasso

FIG. 7, comprising FIGS. 7A and 7B, illustrates a two-finger lasso. A two-finger lasso allows a group of objects to be selected by simultaneously touching two opposite corners of a rectangle that envelops the objects. Resolution of random touch events in a two-finger lasso process is difficult.

FIG. 7 includes a screen space 261, and five graphical constructs 711b, 711c, 711d, 711e, 711f displayed on the canvas. FIG. 7A illustrates a first touch point 721 created by a touch event where one finger, or two fingers in a proximity defined as one touch event, creates the first touch point. Also illustrated is a second touch point 731 created by a touch event where one finger, or two fingers in a proximity defines as one touch event, creates the second touch point. The two simultaneous touch points 721, 731 create a potential group 741.

As the user removes their fingers from the touch points, a group 751 is created. An “he” “create” “group” record is created and the “he” record is communicated to one or more other network nodes, and stored in the local log. The shade of objects 711c, 711d, 711e, and 711f is darkened to indicate membership in the group identified by border 751. And the group border 751 is extended to envelop the five members of the group. In this example, objects within the boundaries, or that overlap the boundaries, of the group 751 border, such as object 711e, are included in the group. Objects such as object 711b that are completely outside the border of the group 751 are not included in the group.

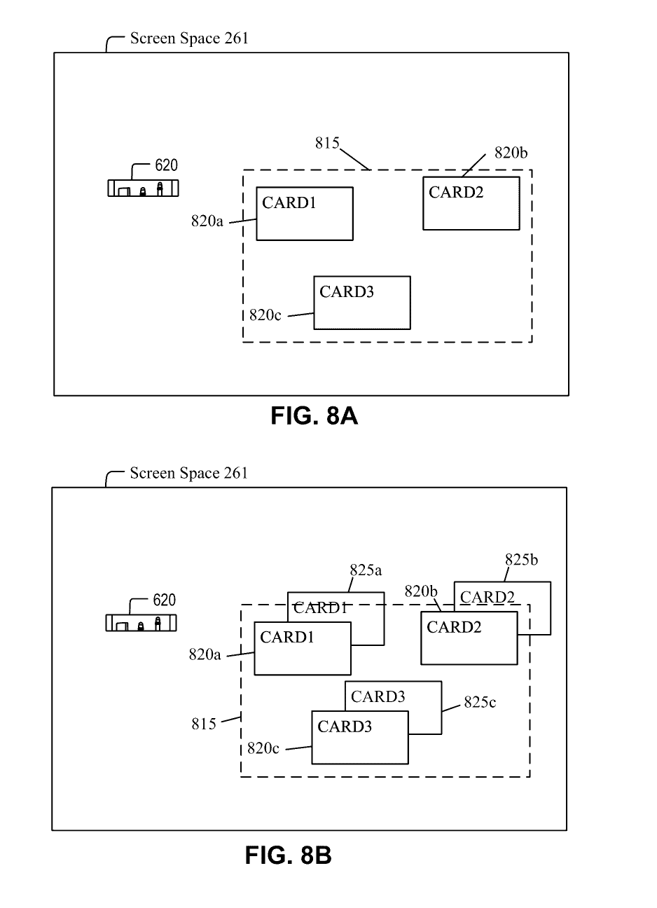

### FIG. 8—Duplicate Group

FIGS. 8A and 8B illustrate a duplication of a group. In one implementation, a multi-touch selection gesture can be initiated by an interaction with a toolbar, such as the toolbar 620 of FIG. 6. The duplicate action creates copies of each object within the group, and places them in an offset of the original item, maintaining the spatial relationships between the new objects.

FIGS. 8A and 8B comprise a screen space 261 with a toolbar 620 displayed within the screen space. In the illustrated example, card1 820a, card2 820b, and card3 820c are three graphical constructs which have been grouped together in a group polygon 815. In this example, the group is identified by a polygon 815 drawn with a dashed line. The shading of the graphical constructs 820a, 820b, and 820c has been set to a grey shade to indicate their membership in the group identified by polygon 815.

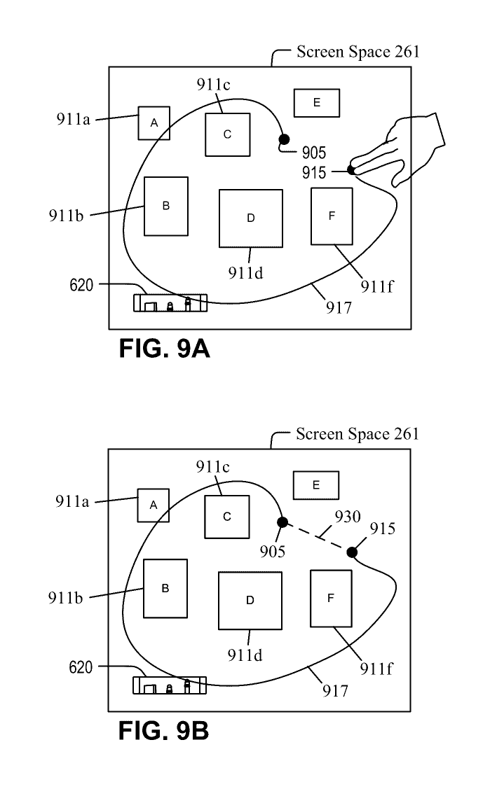

### FIG. 9—Free Form Lasso

FIGS. 9A and 9B illustrate the creation of a group with a free form lasso. A free form lasso is created by touching a screen space at one touch point, invoking a group selection mode in the user input logic, and then drawing a free-form shape around the objects that are to be included in the group. FIGS. 9A and 9B include a screen space 261 with a toolbar 620 displayed within the screen space. Five graphical constructs 911a, 911b, 911c, 911d, and 911f are also included. A first touch point 905, a second touch point 915, and a freehand circle 917 are also included.

While in selection mode, a first touch point 905 is created by a touch event where one finger, or two fingers in a proximity defined as one touch event, creates the first touch point. While still touching the screen space, a freehand line 917 forming a free form polygon is drawn around the objects that are to be included in a group. As the endpoint of the freehand circle 917 approaches within a configurable distance of, or touches, the first touch point 905, the finger is removed from the screen space 261 creating a second touch point 915. If the freehand line 917 is not closed, but the first touch point 905 and the second touch point 915 are within a configurable distance from each other, the network node can calculate a line between the first touch point 905 and the second touch point 915, and use this line to close the freehand line 917 automatically. This is illustrated by line 930 in FIG. 9B. Once closed, the objects within the freehand circle 917 are included in the “he” “create” “group” record. The freehand circle 917 then becomes the boundary of the group. In another implementation, once a freehand circle 917 has been created, tapping objects outside of the freehand circle 917 while still in selection mode will add the objects to the group.

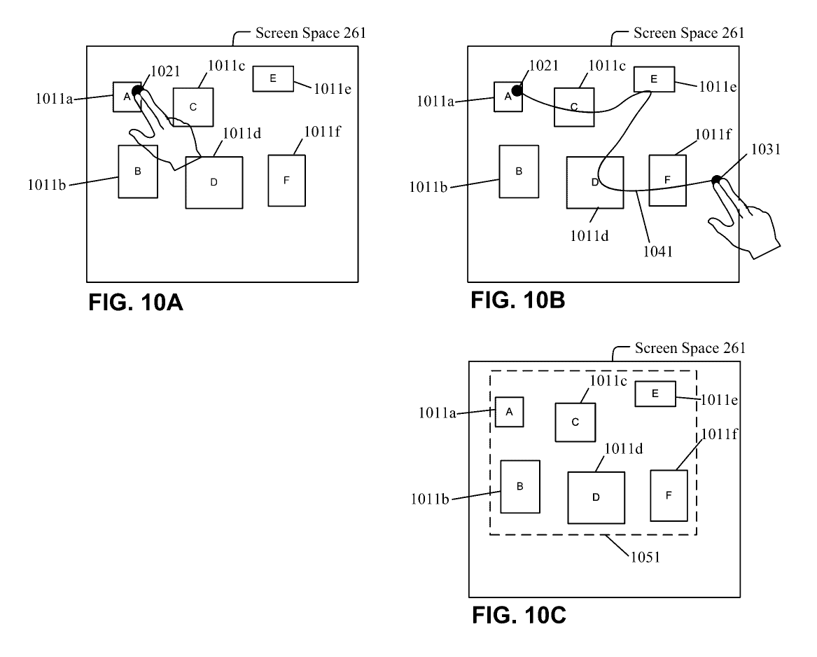

### FIG. 10—Swipe Lasso

FIGS. 10A, 10B, and 10C illustrate the creation of a group with a swipe lasso. A swipe lasso is created by touching a screen space at one touch point, and then drawing a freehand line through the objects that are to be included in the group. FIGS. 10A-10C include a screen space 261 and six graphical constructs 1011a, 1011b, 1011c, 1011e and 1011f. FIG. 10 also includes a first touch point 1021, a second touch point 1031, a freehand line 1041, and a group 1051.

While in selection mode, a touch event creates a first touch point 1021 within the coordinates of object 1011a. The network node processes the data indicating the touch point location, and modifies the object 1011a overlapping the touch point 1021 by changing the shade of the object. While continuing the touch, a freehand line 1041 is drawn through objects 1011c, 1011e, 1011d, and 1011f ending at a second touch point 1031. In one example, as the network node processes the data generated by the freehand line 1041, passing over the coordinates of objects rendered on the screen space 261, the network node changes the shade of those object to indicate the event. Once the user lifts the finger from the second touch point 1031, a rectangle identifying the boundaries of a group 1051 that envelops the selected objects is drawn. In this example, the shade of objects that did not coincide with the freehand line 1041, such as object 1011b, has not changed.

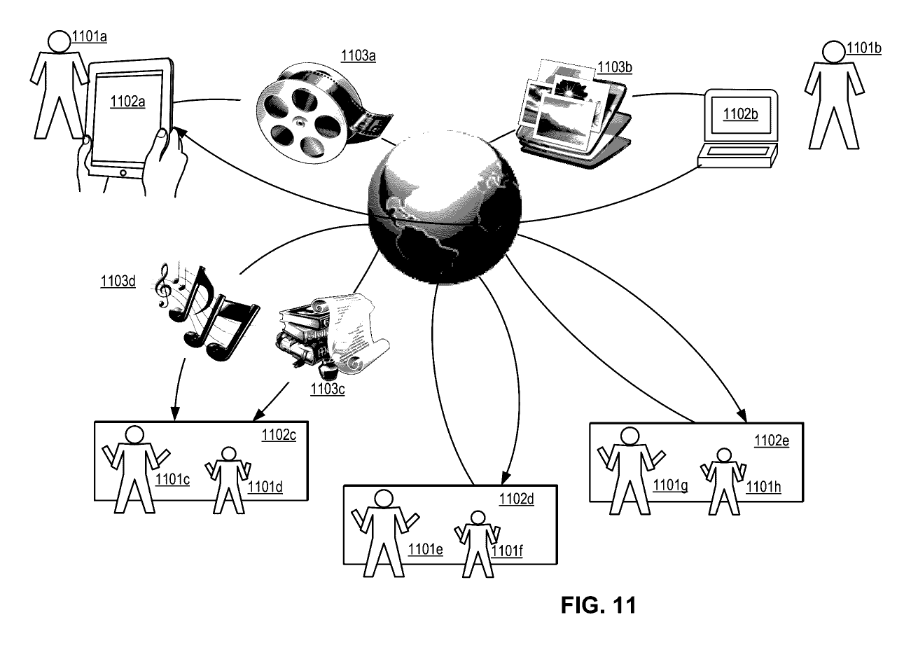

### FIG. 11

FIG. 11 illustrates example aspects of a digital display collaboration environment. In the example, a plurality of users 1101a-h (collectively 1101), may desire to collaborate with each other in the creation of complex images, music, video, documents, and/or other media, all generally designated in FIG. 11 as 1103a-d (collectively 1103). The users in the illustrated example use a variety of devices configured as electronic network nodes, in order to collaborate with each other, for example a tablet 1102a, a personal computer (PC) 1102b, and many large format displays 1102c, 1102d, 1102e (collectively devices 1102). In the illustrated example, the large format display 1102c, which is sometimes referred to herein as a “wall”, accommodates more than one of the users, (e.g. users 1101c and 1101d, users 1101e and 1101f, and users 1101g and 1101h). The user devices, which are referred to as client-side network nodes, have displays on which a screen space is rendered, where the screen space is a displayable area allocated for displaying events in a workspace. The displayable area for a given user may comprise the entire screen of the display, a subset of the screen, a window to be displayed on the screen and so on, such that each has a limited area or extent compared to the virtually unlimited extent of the workspace.

FIG. 12 illustrates additional example aspects of a digital display collaboration environment. As shown in FIG. 12, the large format displays 1102c, 1102d, 1102e sometimes referred to herein as “walls,” are controlled by respective client-side network nodes 1210 on a physical network 1204, which in turn are in network communication with a central collaboration server 1205 configured as a server-side physical network node or nodes, which has accessible thereto a database 1206 storing spatial event map stacks for a plurality of workspaces. As used herein, a network node is an addressable device or function in an active electronic device that is attached to a network, and is capable of sending, receiving, or forwarding information over a communications channel. Examples of electronic devices which can be deployed as network nodes include all varieties of computers, workstations, laptop computers, hand-held computers and smart phones. As used herein, the term “database” does not necessarily imply any unity of structure. For example, two or more separate databases, when considered together, still constitute a “database” as that term is used herein.

The application running at the collaboration server 1205 can be hosted using Web server software such as Apache or nginx, or a runtime environment such as node.js. It can be hosted for example on virtual machines running operating systems such as LINUX. The server 1205 is heuristically illustrated in FIG. 12 as a single computer. However, the server architecture can involve systems of many computers, each running server applications, as is typical for large-scale cloud-based services. The server architecture includes a communication module which can be configured for various types of communication channels, including more than one channel for each client in a collaboration session. For example, with near-real-time updates across the network, client software can communicate with the server communication module using a message-based channel, based for example on the Web Socket protocol. For file uploads as well as receiving initial large volume workspace data, the client software can communicate with the server communication module via HTTPS. The server can run a front-end program written for example in JavaScript served by Ruby-on-Rails, support authentication/authorization based for example on Oauth, and support coordination among multiple distributed clients. The server communication module can include a message based communication protocol stack, such as a Web Socket application, that performs the functions of recording user actions in workspace data, and relaying user actions to other clients as applicable. This system can run on the node.JS platform for example, or on other server technologies designed to handle high-load socket applications.

The database 1206 stores, for example, a digital representation of workspace data sets for a spatial event map comprising the “he” records of each session where the workspace data set can include or identify events related to objects displayable on a display canvas. A workspace data set can be implemented in the form of a spatial event stack, managed so that at least persistent spatial events are added to the stack (push) and removed from the stack (pop) in a first-in-last-out pattern during an undo operation. There can be workspace data sets for many different workspaces. A data set for a given workspace can be configured in a database, or as a machine readable document linked to the workspace. The workspace can have unlimited or virtually unlimited dimensions. The workspace data includes event data structures identifying objects displayable by a display client in the display area on a display wall, and associating a time and a location in the workspace with the objects identified by the event data structures. Each device 1102 displays only a portion of the overall workspace. A display wall has a display area for displaying objects, the display area being mapped to a corresponding area in the workspace that corresponds to a region in the workspace centered on, or otherwise located with, a user location in the workspace. The mapping of the display area to a corresponding area in the workspace is usable by the display client to identify objects in the workspace data within the display area to be rendered on the display, and to identify objects to which to link user touch inputs at positions in the display area on the display.

The server 1205 and database 1206 can constitute a server-side network node, including memory storing a log of events relating to graphical targets having locations in a workspace, entries in the log including a location in the workspace of the graphical target of the event, a time of the event, and a target identifier of the graphical target of the event. The server can include logic to establish links to a plurality of active client-side network nodes, to receive messages identifying events relating to modification and creation of graphical targets having locations in the workspace, to add events to the log in response to said messages, and to distribute messages relating to events identified in messages received from a particular client-side network node to other active client-side network nodes.

The logic in the server 1205 can comprise an application program interface, including a specified set of procedures and parameters, by which to send messages carrying portions of the log to client-side network nodes, and to receive messages from client-side network nodes carrying data identifying “ve” and “he” events relating to graphical targets having locations in the workspace.

Also, the logic in the server 1205 can include an application interface including a process to distribute events received from one client-side network node to other client-side network nodes.

The events compliant with the API can include a first class of event (history event) to be stored in the log and distributed to other client-side network nodes, and a second class of event (ephemeral event) to be distributed to one or more other client-side network nodes but not stored in the log.

The server 1205 can store workspace data sets for a plurality of workspaces, and provide the workspace data to the display clients participating in the session. The workspace data is then used by the computer systems 1210 with appropriate software 1212 including display client software, to determine images to display on the display, and to assign objects for interaction to locations on the display surface. The server 1205 can store and maintain a multitude of workspaces for different collaboration sessions. Each workspace can be associated with a group of users and configured for access only by authorized users in the group.

In some alternatives, the server 1205 can keep track of a “viewport” for each device 1102, indicating the portion of the canvas viewable on that device, and can provide to each device 1102 data needed to render the viewport.

Application software running on the client device responsible for rendering drawing objects, handling user inputs, and communicating with the server can be based on HTML5 or other markup based procedures, and run in a browser environment. This allows for easy support of many different client operating system environments.

The user interface data stored in database 1206 includes various types of objects including graphical constructs, such as image bitmaps, video objects, multi-page documents, scalable vector graphics, and the like. The devices 1102 are each in communication with the collaboration server 1205 via a network 1204. The network 1204 can include all forms of networking components, such as LANs, WANs, routers, switches, WiFi components, cellular components, wired and optical components, and the internet. In one scenario two or more of the users 1101 are located in the same room, and their devices 1102 communicate via WiFi with the collaboration server 1205. In another scenario two or more of the users 1101 are separated from each other by thousands of miles and their devices 1102 communicate with the collaboration server 1205 via the internet. The walls 1102c, 1102d, 1102e can be multi-touch devices which not only display images, but also can sense user gestures provided by touching the display surfaces with either a stylus or a part of the body such as one or more fingers. In some embodiments, a wall (e.g. 1102c) can include sensors and logic that can distinguish between a touch by one or more fingers (or an entire hand, for example), and a touch by a stylus. In an embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 1102c may, for example, be an array of Model No. MT553UTBL MultiTaction Cells, manufactured by MultiTouch Ltd, Helsinki, Finland, tiled both vertically and horizontally. In order to provide a variety of expressive means, the wall 1102c is operated in such a way that it maintains “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

In an illustrative embodiment, a display array can have a displayable area totaling on the order of 6 feet in height and 30 feet in width, which is wide enough for multiple users to stand at different parts of the wall and manipulate it simultaneously. Flexibility of expression on the wall may be restricted in a multi-user scenario, however, since the wall does not in this embodiment distinguish between fingers of different users, or styli operated by different users. Thus if one user places the wall into one desired state, then a second user would be restricted to use that same state because the wall does not have a way to recognize that the second user's input is to be treated differently.

In order to avoid this restriction, the client-side network node can define “drawing regions” on the wall 1102c. A drawing region, as used herein, is a region within which at least one aspect of the wall's state can be changed independently of other regions on the wall. In the present embodiment, the aspects of state that can differ among drawing regions include the properties of a line drawn on the wall using a stylus. Other aspects of state, such as the response of the system to finger touch behaviors may not be affected by drawing regions.

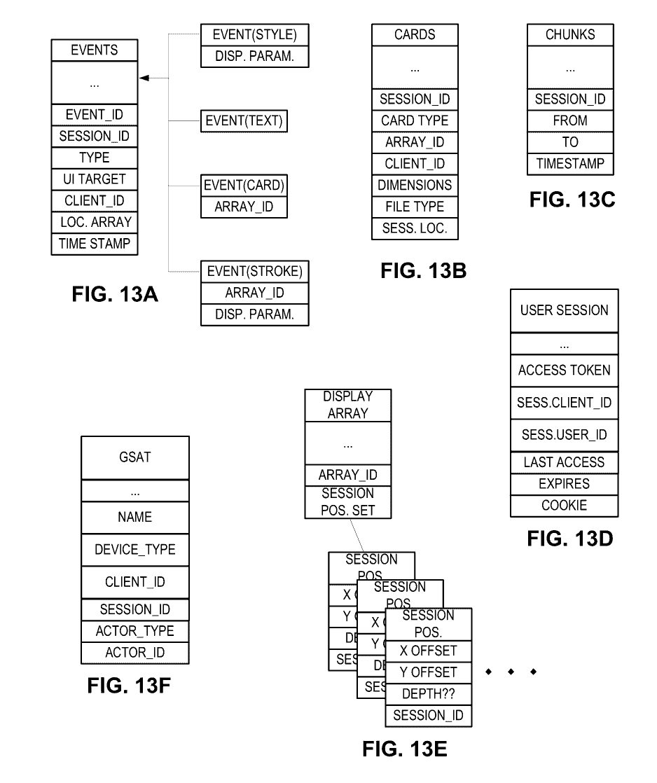

FIGS. 13A-13F represent data structures which can be part of workspace data maintained by a database at the collaboration server 1205. In FIG. 13A, an event data structure is illustrated for events such as Volatile Events or Historic Events. An event is an interaction with the workspace data that can result in a change in workspace data. Thus, an event can include an event identifier, a timestamp, a session identifier, an event type parameter, the client identifier as client-id, and an array of locations in the workspace, which can include one or more for the corresponding event. It is desirable, for example, that the timestamp have resolution on the order of milliseconds or even finer resolution, in order to minimize the possibility of race conditions for competing events affecting a single object. Also, the event data structure can include a UI target, which identifies an object in the workspace data to which a stroke on a touchscreen at a client display is linked. Events can include style events, which indicate the display parameters of a stroke, for example. The events can include a text type event, which indicates entry, modification or movement in the workspace of a text object. The events can include a card type event, which indicates the creation, modification or movement in the workspace of a card type object. The events can include a stroke type event which identifies a location array for the stroke, and display parameters for the stroke, such as colors and line widths for example.

Events can be classified as persistent history events and as ephemeral events. Processing of the events for addition to workspace data, and sharing among users can be dependent on the classification of the event. This classification can be inherent in the event type parameter, or an additional flag or field can be used in the event data structure to indicate the classification.

A spatial event map can include a log of events having entries for history events, where each entry comprises a structure such as illustrated in FIG. 13A. A server-side network node includes logic to receive messages carrying ephemeral and history events from client-side network nodes, and to send the ephemeral events to other client-side network nodes without forwarding them to a server at which events are added as corresponding entries in the log, and to send history events to the other client-side network nodes while forwarding them to a server at which events are added as corresponding entries to the log.

FIG. 13B illustrates a card data structure. The card data structure can provide a cache of attributes that identify current state information for an object in the workspace data, including a session identifier, a card type identifier, an array identifier, the client identifier, dimensions of the cards, type of file associated with the card, and a session location within the workspace.

FIG. 13C illustrates a data structure which consolidates a number of events and objects into a cacheable set called a chunk. The data structure includes a session ID, an identifier of the events included in the chunk, and a timestamp at which the chunk was created.

FIG. 13D illustrates the data structure for links to a user participating in a session in a chosen workspace. This data structure can include an access token, the client identifier for the session display client, the user identifier linked to the display client, a parameter indicating the last time that a user accessed a session, and expiration time and a cookie for carrying various information about the session. This information can, for example, maintain a current location within the workspace for a user, which can be used each time that a user logs in to determine the workspace data to display at a display client to which the login is associated.

FIG. 13E illustrates a display array data structure which can be used in association with large-format displays that are implemented by federated displays, each having a display client. The display clients in such federated displays cooperate to act as a single display. The workspace data can maintain the display array data structure which identifies the array of displays by an array ID, and identifies the session position of each display. Each session position can include an x-offset and a y-offset within the area of the federated displays, a session identifier, and a depth.

The system can encrypt communications with client-side network nodes, and can encrypt the database in which the spatial event maps are stored. Also, on the client-side network nodes, cached copies of the spatial event map are encrypted in some embodiments, to prevent unauthorized access to the data by intruders who gain access to the client-side computers.

FIG. 13F illustrates a Global Session Activity Table (GSAT) used to map active clients to active workspaces. The data structure includes a workspace name, a device type, a client ID, a session ID, and actor type, and an actor ID.

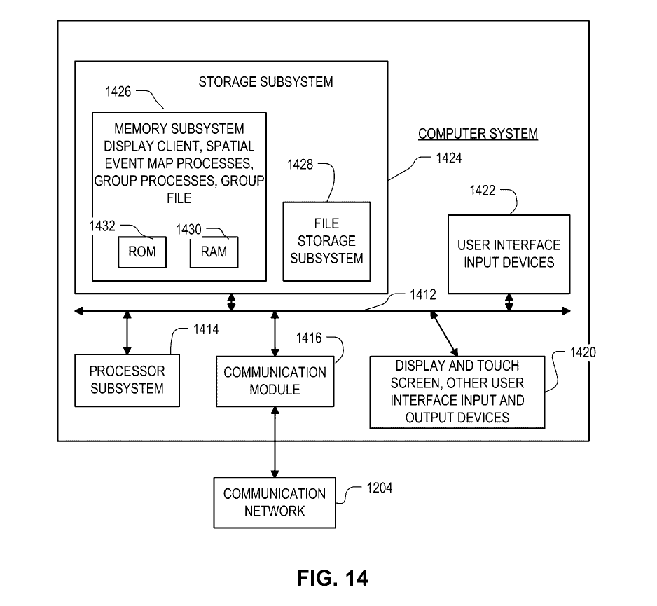

FIG. 14 is a simplified block diagram of a computer system, or network node, which can be used to implement the client-side functions (e.g. computer system 1210) or the server-side functions (e.g. server 1205) in a distributed collaboration system. A computer system typically includes a processor subsystem 1414 which communicates with a number of peripheral devices via bus subsystem 1412. These peripheral devices may include a storage subsystem 1424, comprising a memory subsystem 1426 and a file storage subsystem 1428, user interface input devices 1422, user interface output devices 1420, and a network interface subsystem within a communication module 1414. The input and output devices allow user interaction with the computer system. Communication module 1416 provides physical and communication protocol support for interfaces to outside networks, including an interface to communication network 1204, and is coupled via communication network 1204 to corresponding communication modules in other computer systems. Communication network 1204 may comprise many interconnected computer systems and communication links. These communication links may be wireline links, optical links, wireless links, or any other mechanisms for communication of information, but typically it is an IP-based communication network, at least at its extremities. While in one embodiment, communication network 1204 is the Internet, in other embodiments, communication network 1204 may be any suitable computer network.

The physical hardware components of network interfaces are sometimes referred to as network interface cards (NICs), although they need not be in the form of cards: for instance, they could be in the form of integrated circuits (ICs) and connectors fitted directly onto a motherboard, or in the form of macrocells fabricated on a single integrated circuit chip with other components of the computer system.

User interface input devices 1422 may include a keyboard, pointing devices such as a mouse, trackball, touchpad, or graphics tablet, a scanner, a touch screen incorporated into the display (including the touch-sensitive portions of large format digital display 1102c), audio input devices such as voice recognition systems, microphones, and other types of tangible input devices. In general, use of the term “input device” is intended to include all possible types of devices and ways to input information into the computer system or onto computer network 1204.

User interface output devices 1420 include a display subsystem that comprises a screen and a touch screen overlaying the screen, or other input device for identifying locations on the screen, a printer, a fax machine, or non-visual displays such as audio output devices. The display subsystem can include a cathode ray tube (CRT), a flat panel device such as a liquid crystal display (LCD), a projection device, or some other mechanism for creating a visible image. In the embodiment of FIG. 12, it includes the display functions of large format digital display 1102c. The display subsystem may also provide non-visual display such as via audio output devices. In general, use of the term “output device” is intended to include all possible types of devices and ways to output information from the computer system to the user or to another machine or computer system.

Storage subsystem 1424 stores the basic programming and data constructs that provide the functionality of certain embodiments of the technology disclosed.

The storage subsystem 1424 when used for implementation of server-side network nodes, comprises a product including a non-transitory computer readable medium storing a machine readable data structure including a spatial event map which locates events in a workspace, wherein the spatial event map includes a log of events, entries in the log having a location of a graphical target of the event in the workspace and a time. Also, the storage subsystem 1424 comprises a product including executable instructions for performing the procedures described herein associated with the server-side network node.

The storage subsystem 1424 when used for implementation of client-side network nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 1424 comprises a product including executable instructions for performing the procedures described herein associated with the client-side network node.

For example, the various modules implementing the functionality of certain embodiments of the technology disclosed may be stored in storage subsystem 1424. These software modules are generally executed by processor subsystem 1414.

Memory subsystem 1426 typically includes a number of memories including a main random access memory (RAM) 1430 for storage of instructions and data during program execution and a read only memory (ROM) 1432 in which fixed instructions are stored. File storage subsystem 1428 provides persistent storage for program and data files, and may include a hard disk drive, a floppy disk drive along with associated removable media, a CD ROM drive, an optical drive, or removable media cartridges. The databases and modules implementing the functionality of certain embodiments of the technology disclosed may have been provided on a computer readable medium such as one or more CD-ROMs, and may be stored by file storage subsystem 1428. The host memory subsystem 1426 contains, among other things, computer instructions which, when executed by the processor subsystem 1414, cause the computer system to operate or perform functions as described herein. As used herein, processes and software that are said to run in or on “the host” or “the computer,” execute on the processor subsystem 1414 in response to computer instructions and data in the host memory subsystem 1426 including any other local or remote storage for such instructions and data.

Bus subsystem 1412 provides a mechanism for letting the various components and subsystems of a computer system communicate with each other as intended. Although bus subsystem 1412 is shown schematically as a single bus, alternative embodiments of the bus subsystem may use multiple busses.

The computer system itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display 1102c. Due to the ever-changing nature of computers and networks, the description of computer system 1210 depicted in FIG. 14 is intended only as a specific example for purposes of illustrating the preferred embodiments of the technology disclosed. Many other configurations of the computer system are possible having more or less components than the computer system depicted in FIG. 14. The same components and variations can also make up each of the other devices 1102 in the collaboration environment of FIG. 11, as well as the collaboration server 1205 and display database 1206.

In one type of embodiment, one or more of the client connection layer, message passing layer and collaboration layer can be implemented as virtual machines including network nodes in a physical machine hosted by a third party, and configured by computer programs to provide the services described herein.

The Application Program Interface used for messaging of events can be used by code developed for group management. The Memory Subsystem can store computer programs executable by the processor subsystem 1414 implementing client-side process for group selection, creation, movement, modification and deletion as described above. Also, computer programs for client-side processes executable by the processor subsystem 1414 for interpreting touch events and other user inputs supporting group processes can be included in the Memory Subsystem. Also, computer programs executable by the processor subsystem 1414 can implement the client-side functions and parameters for the spatial event map API as described herein.

For group management, the related code stored in the Memory Subsystem can include a file that acts as a repository of all groups existing in a workspace as determined using the spatial event map and current events in the local node, both potential groups during a selection or modification process, and final groups. It also implements the parser for group events received from a database that stores the history of events in the workspace, and handles sending events to the database whenever a group action has been performed locally such as adding members to a group, or moving the group.

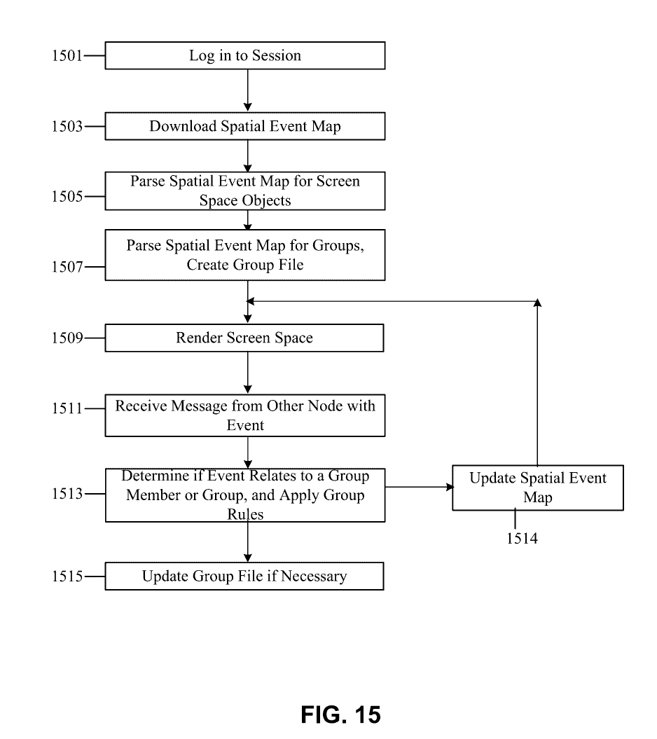

FIG. 15 illustrates logic implemented using a computer program stored in a storage subsystem and executed by a client-side node relating to group processing as described herein, for events indicated in messages received from other nodes. The process includes logging into a session for a workspace 1501. After logging in, the spatial event map for the session is downloaded to the client-side node 1503. The client-side node parses the spatial event map for objects (graphical target of events) in the viewport which maps to the screen space on the client-side node 1505. The client-side node also parses the spatial event map to identify groups that have been created, and the members in such groups. A group file is created for use with the local logic and for maintaining this information for use in interpreting events which are identified in messages received from other nodes and user inputs which are received from user input devices at the client-side node 1507.

Using the information produced by parsing the spatial event map, the screen space on the client-side node is rendered, resulting in display of the graphical targets within the viewport 1509. During the session, a message can be received from another node which identifies an event executed in the workspace 1511. The client-side node determines if the event carried in the message relates to a group member or a group, and if so applies group rules to interpreting the event 1513. The event is added to the spatial event map 1514, and the screen space is rendered 1509 with the updated information if necessary. Also, the group file is updated if necessary in response to the received event 1515. Group rules as the term is used here includes executing an action using a procedure that applies to all members of a group.

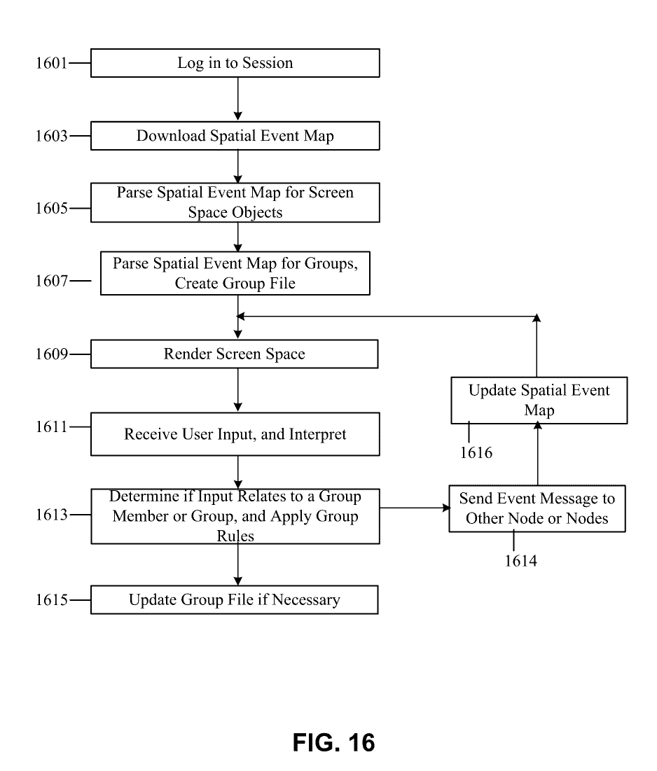

FIG. 16 illustrates logic implemented in a computer program stored in a storage subsystem and executed by a client-side node related to group processing as described herein, for inputs generated locally at the client-side node. The process includes logging in to a session for a workspace 1601. After logging in the spatial event map for the session is downloaded to the client-side node 1603. The logic on the client-side node parses the spatial event map for screen space objects, that is objects (graphical target of events) having locations in the viewport which maps to the screen space on the client-side node 1605. Logic on the client-side node also parses the spatial event map for groups, and creates a group file as mentioned above 1607.

Using the information produced by parsing the spatial event map, the screen space on the client-side node is rendered, resulting in display of the graphical targets within the viewport 1609. During the session, user input generated at the client-side node, such as touch events, gestures, keyboard inputs, mouse inputs and the like, is received and interpreted 1611. The logic on the client-side node determines whether the input relates to a group member, or a group using the group file. If it is related, then group rules are applied to the interpretation of the input 1613. On interpretation of the input, a message is composed and sent to other nodes 1614. Also, the spatial event map on the client-side node is updated if necessary 1616.

If the event involves a graphical target within the screen space, then the screen space is rendered again using the new information 1609. Logic on the client-side node also updates the group file if necessary after interpreting input.

### API

Socket Requests Server (WebSockets)—used for updating clients with relevant data (new strokes, cards, clients, etc.) once connected. Also handles the initial connection handshake.

Service Requests Server (HTTPS/REST)—used for cacheable responses, as well as posting data (i.e. images and cards)

Client-side network nodes are configured according to the API, and include corresponding socket requests clients and service requests clients.

All messages are individual UTF-8 encoded JSON arrays. For example:

[sender-id, message-type, . . . ]
sender-id the ID of the client sending the message, or “−1” if the message originates with the server. Sender-ids are unique among all clients connected to the server.
message-type a short code identifying the remaining arguments and the intended action.

### Establishing a Connection

Clients use the Configuration Service to retrieve the configuration information for the environment. The socket server URL is provided by the ws_collaboration_service_address key.

1) To Open the WebSocket and Join a Specific Workspace
<collaboration_service_address>/<workspaceId>/socket?device=<device>array=<array_name>
   workspaceId (string) the id of the workspace to join
   device (string) a device type. Supported values: wall, other
   array (string) an identifier for multiple screen instances. (optional)

2) To Join the Lobby

The lobby allows a client to open a web socket before it knows the specific workspace it will display. The lobby also provides a 5-digit PIN which users can use to send a workspace to the wall from their personal device (desktop/ios).

<collaboration_service_address>/lobby/socket?device=<device>&array=<array_name>
device (string) a device type. Supported values: wall, other
array (string) an identifier for multiple screen instances. (optional)
3) Server Response

When a client establishes a new web-socket connection with the server, the server first chooses a unique client ID and sends it in an “id” message to the client with the unique client ID.

4) Message Structure

The first element of each message array is a sender-id, specifying the client that originated the message. Sender-ids are unique among all sessions on the server. The id and cr messages sent from the server to the client have their sender-id set to a default value, such as −1. The second element of each message array is a two-character code. This code defines the remaining arguments in the array as well as the intended action. Messages sent with a sender-id of −1 are messages that originate from the server.

### Message Types

The following messages types are officially supported. Since Spring 2013 there has been an effort to use he and ve when possible instead of adding new top level message types.

1) cs Change Session

2) echo Echo

3) error Error

4) id Client Id

5) jr Join Room

6) rl Room List

7) un Undo

8) up User Permissions

9) vc Viewport Change

10) he History Event

11) ve Volatile Event

12) disconnect Disconnect

13) ls List Streams

14) bs Begin Stream

15) es End Stream

16) ss Stream State

17) oid Object Id Reservation

1) cs Change Session

Inform a client or siblings in a display array that the workspace has changed. The server sends this message to the client when it receives request to send a workspace to a wall.

// server --> client
[sender-id, “cs”, workspaceId]

sender-id always −1 (indicating the server initiated the message)
workspaceId (string) is the id of the workspace to switch to
2) echo Echo

Echos an optional body back to the originating client. Used to verify that the socket connection and the server are still healthy.

// client --> server
[sender-id, “echo”, “foo”, “bar”...]
// server --> client
[−1, “echo”, “foo”, “bar”...]

After “echo” the message can take any arguments. They will all be echoed back to the client unaltered if the service and the client's socket connection are healthy. When using the echo message to verify socket health we recommend the following:
Wait at least 5 seconds between echo messages
Require 2 consecutive echo failures before assuming network or server problems

This message was added to the protocol because the current implementation of Web Sockets in Chrome and other supported browsers do not correctly change readyState or fire onclose when network connection dies.

3) error Error

Informs clients of an error on the server side.

// server -> client
[“−1”, “error”, target-id, message]

target-id the guid for the object in the session that the error affects
message a message about the error.

This message is only sent by the server and currently only used when an upload fails during asynchronous processing.

4) id Client Id

The server sends this message when the client connects to the socket. Clients are required to store the assigned client ID for use in subsequent socket requests.

// server --> client
[“−1”, “id”, client-id]

client-id (string) the ID of the newly-joined client

5) jr Join Room

Rooms are communication channels that a client can subscribe to. There can be channels for specific workspaces (sessions), for display arrays, or potentially for other groups of clients. The server repeats/sends messages to all the clients connected to a specific room as events happen in that room. A client joins a room to get messages for that display array or workspace (session). There are several types of join room requests.

### General Jr

Join any room if you know the id.

// server <-- client
[sender-id, “jr”, room-id, [data]]

room-id can contain one of lobby or workspace id
data is a wildcard set of arguments, which should be used to initialize the room.

### Lobby Jr

Joins the lobby channel. Used by clients that wish to keep a web socket open while not displaying a workspace.

// server <-- client
[sender-id, “jr”, “lobby”]

### Session Jr

Joins the room for a specific workspace (session).

// server <-- client
[sender-id, “jr”, “session”, workspace-id]

workspace-id the id of the workspace (workspace)

### Array Jr

Joins the room for a specific display array.

```
// server <-- client
[sender-id, “jr”, “array”, {
  arrayId: “myArrayId”,
  x: 0,
  y: 0,
  width: 1920,
  height: 1080
}]
```

arrayId (string) id of the display array
x (integer) x offset of this display
y (integer) y offset of this display
width (integer) width of this display
height (integer) height of this display

### Room Join Response:

The server responds to successful room join (jr) messages with a room message.

General room

// server --> client
[“−1”, “room”, [room-id], [databag]]

room-id contains one of: lobby or workspace
databag is a room-specific bag of variables:
   Lobby room

// server --> client
[“−1”, “room”, “lobby”, {pin: pin-code}]

pin containing the pin for wall authentication

### Session Room

```
// server --> client
[“−1”,“room”,“session”,{“uid”:“SU5DVpxbfnyGCesijBou”,“name”:
      “Dec 16 Release”,“sharing_link”:“https://portal.bluescape.com/
      sessions/1357/shares”}]‘‘
```

‘uid’ the id of the workspace
‘name’ the name of the workspace to show in the client
‘sharing_link’ a link to the portal page where a user can share this workspace with others
6) rl Room List

Informs the client of the room memberships. Room memberships include information regarding clients visiting the same room as you.

// server --> client
[“−1”, “rl”, roomMembershipList]

roomMembershipList (array of room membership objects)
   A room membership object is a hash with the following keys
name User or device name
device_type The type of device the user is on, currently wall or other.

(Deprecated)
clientId The clientId of this device
clientType The type of client (browser, ipad, or wall)
viewport (optional) If the client provides a viewport rect the server will repeat it to all clients.

7) un Undo

Undoes the last undo-able action (move, set text, stroke, etc).

// server <-- client
[sender-id, “un”, region-id]
// server --> client
[client-id, ‘undo’, target-id, removedEventId]

Undo Example: Move a Window and then Undo that Move

The following example shows a move, and how that move is undone.

```
// Client sends move
[“5122895cff31fe3509000001”,“he”,“5122898bff31fe3509000002”,
“position”,{
  “rect”:[257,357,537,517],
  “order”:2
}]
// Server response
[“5122895cff31fe3509000001”,“he”,“5122898bff31fe3509000002”,
      “5122898efde0f33509000008”,“position”,{
  “rect”:[257,357,537,517]
  ,“order”:2
}]
// Client sends undo [<clientId> , ‘un’, <canvasRegionId>]
[“5122895cff31fe3509000001”,“un”,null]
// Server response
// [<clientId>, ‘undo’, <targetId>, <removedMessageId>]
[“−1”,“undo”,“5122898bff31fe3509000002”,
“5122898efde0f33509000008”]
```

The server removes the history event from the workspace history and notifies all clients subscribed to the room that this record will no longer be a part of the workspace's historical timeline. Future requests of the history via the HTTP API will not include the undone event (until we implement redo).

8) up User Permissions

Gets the permissions that the current user has for this workspace. Only relevant when a client is acting as an agent for a specific user not relevant when using public key authentication (walls).

// server --> client
[sender-id, “up”, permissions]

Permissions a hash of permission types and true/false to indicate if the authenticated user has that permission. Currently the only permission is “can_share” indicating users who can share the workspace with others.

9) vc Viewport Change

Updates other clients in a session that one client's viewport has changed. This is designed to support the “jump to user's view” and “follow me” features. Clients must send a VC upon entering a session for the first time. This ensures that other clients will be able to follow their movements. When processing incoming VC events, clients must keep a cache of viewports, keyed by client ID. This is in order to handle occasions where room list membership (rl) events with missing viewports arrive after associated VC events. A change in a target viewport to a revised target viewport can includes a change in the size of the viewport in one or the other dimension or both, which does not maintain the aspect ratio of the viewport. A change in a target viewport can also include a change in the page zoom of the viewport. When subject client-side viewports in “jump to user's view” or “follow-me” mode receive a first ‘vc’ record, it is an instruction for mapping a displayable area of the subject client-side viewport to the area of a target viewport. A subsequent ‘vc’ record results in a remapped displayable area of the subject client-side viewport to the target viewport. When the “jump to user's view” or “follow me” feature is disabled, the subject client-side viewport returns to its prior window.

// server <--> client
[sender-id, “vc”, viewport-rect]

viewport-rect an array in the form [x1, y1, x2, y2] representing the section of the workspace viewable on the sending client.

10) he History Event

History events are pieces of data that are persisted to the database. Any information that is necessary for recreating a visual workspace should be sent to the collaborative service via he messages.

### Examples

Creation of notes, images, and other widgets

Moving widgets

Setting or updating attributes of widgets (e.g. note text, marker locations)

Deleting widgets

When the server receives a history event it does the following:

Assign the event an unique id

Persist the event to the database

Broadcast the event, with its id, to all clients connected to the workspace

### History Event Basic Message Format

// server <-- client
[client-id, “he”, target-id, event-type, event-properties]

client-id (string) the ID of the originating client
target-id (string) the ID of the target object/widget/app to which this event is relevant
event-type (string) an arbitrary event type
properties (object) a JSON object describing pertinent key/values for the event
   regionId (string) the canvas region identifier if the object is created in a canvas region (optional, will be included if it was included in the history event sent by the client)

All properties included in a message will be stored on the server and echoed back to clients. They will also be included in the history sent over http.

// server --> client
[client-id, “he”, target-id, event-id, event-type, event-properties]

client-id (string) the ID of the originating client
target-id (string) the ID of the target window to which this event is relevant
event-id (string) the ID of the event in the database
event-type (string) an arbitrary event type
properties (object) a JSON object describing pertinent key/values for the event
   regionId (string) the canvas region identifier if the object is created in a canvas region (optional, will be included if it was included in the history event sent by the client)

### Batch History Events

In order to ensure ordering of tightly coupled events, many can be sent in a batch message by changing the event payload to be an array of event payloads.

// server <-- client
[client-id, “bhe”, [event1, event2,event3,event4]]

In this case, each event is a packet send as a standard web socket history message.

The event structure is:
[targetId, eventType, props]

So, the clientId portion is not repeated, but all else is as a standard event.

### Current History Event Types

create Add a widget to the workspace
delete Remove the widget from the workspace
position Update the size or location of the widget in the workspace
template Change a card template (background color)
membership Update the target children. Used for groups.
pin Pin or unpin a widget
stroke Add a pen or eraser stroke to a widget
text Sets or update the text and/or text formatting of a note.
markercreate Creates a location marker
markermove Moves an existing location marker
markerdelete Deletes an existing location marker
tsxappevent Used for creating, deleting, and updating tsx widgets such as web browsers
navigate Used for navigating to different page inside group documents (MS docs/PDF)

Widgets And History Events Table

| | | im- | work- | web | location | | | |
|---|---|---|---|---|---|---|---|---|
| | note | age | space | browser | marker | pdf | group | doc |
| create | X | X | | | * | † | X | X |
| delete | X | X | | | * | † | X | X |
| position | X | X | | | * | † | X | X |
| template | X | | | | | | | |
| membership | | | | | | | X | |
| pin | X | X | | | | † | | X |
| stroke | X | X | X | | | | | |
| text | X | | | | | | | |
| markercreate | | | | | X | | | |
| markermove | | | | | X | | | |
| markerdelete | | | | | X | | | |
| tsxappevent | | | | X | | | | |
| navigate | | | | | | | | X |

* The browser client supports receiving alternative versions of these messages but does not send them out to other clients.
† Supported by collaboration system but not currently supported by any client.

### History Event Details

### Comments

Comments are stored in the history database, but are associated with a particular object rather than a position on the plane.

```
// client --> server
[client-id, “he”, target-id, “create”, {
  “id”:“5123e7ebcd18d3ef5e000001”,
  “type”:“comment”,
  “text”:“text of the comment”,
  “parent”:“5123e7ebcd18d3ef5e000000”}]
Server will append ‘name’ to the body of the comment into the props
    object. The parent prop is optional and is an id
[client-id, “he”, comment-id, “delete”}]
[client-id, “he”, comment-id, “text”, {“text”:“text of the comment”}]
```

create

Clients send ‘create’ to the collaboration server to add a widget to a workspace. For ‘create’ messages the target-id is the id of the containing element, usually the workspace-id.

### Generic Widget Create Example

```
// client --> server
[client-id, “he”, workspace-id, “create”, {
  “id”:“5123e7ebcd18d3ef5e000001”,
  “type”:“widget”,
  “regionId”:null
}]
```

Props
id (string) unique identifier for the widget
type (string) the type of widget
regionId (string) the canvas region if the object is created in a canvas region

Most widgets will also have a location property, usually a rect and order, but potentially a point or other representation.

### Card Create Example

```
// client --> server
[client-id, “he”, workspace-id, “create”, {
  “id”:“5123e7ebcd18d3ef5e000001”,
  “baseName”:“sessions/all/Teal”,
  “ext”:“JPEG”,
  “rect”:[−1298,−390,−1018,−230],
  “actualWidth”:560,
  “actualHeight”:320,
  “order”:4,
  “type”:“note”,
  “regionId”:null,
  “hidden”:false,
  “text”:“some text for the note”,
  “styles”: {
    “font-size” : “42px”,
    “font-weight” : “400”,
    “text-transform” : “inherit”
  }
}]
```

Props
id (string) unique identifier for the window
baseName (string) the background image file name
ext (string) the background image file extension
rect (object) the location of the window
actualWidth (int) the background image width in pixels
actualHeight (int) the background image height in pixels
order (int) z order
type (string) “note” for objects that can have text, “image” for other objects
regionId (string) the canvas region if the object is created in a canvas region
hidden (boolean) whether the window is currently hidden
text (string) the text contained in the note (optional)
styles (object) style for the text contained in the note (optional)

### PDF Create Example

```
// server --> client
[client-id,
“he”,
target-id,
event-id,
“create”,
{“type”:“pdf”,
“id”:“5307ec25a294d9250bf65fce”,
    “assetPath”:“sessions/objects/s7t6mNHxfpqWxAYqYXLF/
    5307ec25a294d9250bf65fce.pdf”,
“rect”:[1770,284,2994,1076],
“actualWidth”: 1224,
“actualHeight”: 792,
“filename”:“5617_FSPLT1_018078.pdf”,
“title”:“Record of Decision”,
“hidden”:false,
“pin”:false
“pages”:73}]
```

Props
type (string) “pdf”
id (string) unique identifier for the pdf
assetPath (string) the location of this asset on the asset server. Use configuration service to get the asset base path.
rect (object) the location of the window in the workspace
actualWidth (int) the width of the widest page in the pdf, combined with actualHeight to build “bounding box”
actualHeight (int) the height of the tallest page in the pdf, combined with actualWidth to build “bounding box”
filename (string) the original file name of the pdf
order (int) z order
hidden (boolean) whether the window is currently hidden
pin (boolean) whether the pdf is pinned in one location on the workspace
regionId (string) the canvas region if the object is created in a canvas region (optional)

### Group Create Example (See Above)

### Generic, Group Position Example (See Above)

### Membership (See Above)

### Group Document Create Example (See Above)

### Presentation Create Example

// client --> server
[client-id,
“he”,
target-id,
“create”,
{“type”:“presentation”,
“id”:“53a52b39250f62fce”,
“children”: [ ]}]

Props
type (string) “presentation”
id (string) unique identifier for the group
children (array) array of target-id's of widgets that should part of the presentation in order of presentation

### Presentation Create Example

// server --> client
[ client-id,
“he”,
target-id, // presentation id
event-id,
“create”,
{
“type”:“presentation”,
“children”: [
“id0398749123”,
“id1838094221”,
“id2849239042”,
“id3849012830”]}]

Props
type (string) “presentation”
children (array) array of child(page) object IDs, array order represents the child(page) order.
   delete

Removes a widget from a workspace.

// server <-- client
[client-id, “he”, target-id, “delete”, {“hidden”:true}]
// server --> client
[client-id, “he”, target-id, event-id, “delete”, {“hidden”:true}]

position
Used to save the position of a widget after a move, fling, resize, etc Generic Widget Position Example

// server <-- client
[client-id, “he”, target-id, “position”, {new-position}]
// server --> client
[client-id, “he”, target-id, event-id, “position”, {new-position}]

Props
new-position (object) some way to represent the new position of the object. See the window example.

### Generic Window Position Example

// server <-- client
[client-id, “he”, target-id, “position”, {“rect”:[−1298,−390,−1018,−230],
“order”:4}]
// server --> client
[client-id, “he”, target-id, event-id, “position”, {“rect”:[−1298,−390,
−1018,−230],“order”:4}]

Props
rect (object) the location of the target window. Specified as x1, y1, x2, y2
order (int) the z-order of the target window
   template

Used to change the template for a note. This allows changing the background color.

### Note Template Example

// server --> client
[client-id, ″he″, workspace-id, event-id, ″template″,
{″baseName″: ″sessions/all/Beige″}]

Props
baseName (string) the file name of the new background. The file must be already on the collaboration server. The list of templates is available via the http-protocol at/card_templates.json

Used to pin a widget and prevent users from moving or resizing that widget. Also used to remove an existing pin.

### Generic Widget Position Example

// server --> client
[client-id, ″he″, workspace-id, event-id, ″pin″, {″pin″: true}]

Props
pin (boolean) true is pin, false is un-pin stroke

Used to add a stroke to a widget or to the workspace background.

### Generic Stroke Example

```
// server <-- client
[client-id, ″he″, target-id, ″stroke″, {
  ″size″: 10,
  ″brush″: 1,
  ″color″: [255, 153, 0, 1],
  ″locs″: [850, 616, 844, 617],
  ″regionId″: 59.1
}]
// server --> client
[client-id, ″he″, target-id, event-id, ″stroke″, {
  ″size″: 10,
  ″brush″: 1,
  ″color″: [255, 153, 0, 1],
  ″locs″: [850, 616, 844, 617],
  ″regionId″: 59.1
}]
```

Props
size (integer) diameter of the stroke using the coordinate space of the containing object. Strokes on the canvas are sized in world space, while strokes on widgets are sized in their parent widget space.
brush (integer) the brush type to use when rendering the stroke. 1 is the draw brush, while 2 is the erase brush.
color (numbers) r/g/b/a values for the color of the stroke. Ignored for erase strokes (although may still be present).
locs (array) stroke locations in the format: [10, 1, 10, 2, 12, 3] where coordinates are paired [x, y, x, y, x, y, . . . ] in an array. Similar to size, locations are in the coordinate space of the containing object.
regionId (string) the canvas region if the stroke is created in a canvas region (optional).

Rendering note: strokes should be rendered with end caps centered on the first and last points of the stroke. The end cap's diameter should be equal to the brush size. Rendering end caps is the responsibility of each client.

text

Set the text and style of text on a widget. Both the text attribute and style attribute are optional.

```
Generic Text Example
// server <-- client
[client-id, ″he″, target-id, ″text″, {
  ″text″ : ″abcdef″,
  ″styles″ : {″font-size″ : ″42px″,″font-weight″ : ″400″,″text-transform″:
″inherit″}
}]
// server --> client
[client-id, ″he″, target-id, event-id, ″text″, {
  ″text″ : ″abcdef',
  ″styles″ : {
    ″font-size″ : ″42px″,
    ″font-weight″ : ″400″,
    ″text-transform″ : ″inherit″
  }
}]
```

Props
text (string) the text string to show on the widget
styles (hash) the css styles to apply to the text markercreate

Creates a location marker (map marker, waypoint) at a specific place in the workspace

### Example

```
// server <-- client
[client-id, ″he″, new-widget-id, ″markercreate″,{
  ″creationTime″:1387565966,
  ″name″:″my marker″,
  ″y″:1828,
  ″x″:-875,
  ″color″:0
}]
// server --> client
[client-id, ″he″, new-widget-id, event-id, ″markercreate″,{
  ″creationTime″:1387565966,
  ″name″:″my marker″,
  ″y″:1828,
  ″x″:-875,
  ″color″:0
}]
```

Props
creationTime (int) the creation time (unix time)
name (string) a label for the location marker
y (number) the y location of the marker
x (number) the x location of the marker
template (string) the marker template name

### Alternative Form Accepted by Browser Client

```
// server <-- client
[client-id, ″he″, session-id, ″create″,{
  ″id″:″52b0f86ac55697ad30003b21″
  ″type″:″locationMarker″,
  ″creationTime″:1387565966,
  ″name″:″my marker″,
  ″y″:1828,
  ″x″:-875,
  ″template″:″red″
}]
// server --> client
[client-id, ″he″, session-id, event-id, ″create″,{
  ″id″:″52b0f86ac55697ad30003b21″
  ″type″:″locationMarker″,
  ″creationTime″:1387565966,
  ″name″:″my marker″,
  ″y″:1828,
  ″x″:-875,
  ″template″:″red″
}]
```

markermove

Moves an existing location marker (map marker, waypoint) to a new place in the workspace.

### Example

```
// server <-- client
[client-id, ″he″, marker-id, ″markermove″,{
  ″y″:1828,
  ″x″:-875,
}]
// server -->client
[client-id, ″he″, marker-id, event-id, ″markermove″,{
  ″y″:1828,
  ″x″:-875,
}]
```

Props
y (number) the y location of the marker
x (number) the x location of the marker

### Alternative Form Accepted by Browser Client

```
// server <-- client
[client-id, ″he″, target-id, ″position″,{
  ″y″:1828,
  ″x″:-875,
}]
// server --> client
[client-id, ″he″, target-id, event-id, ″position″,{
  ″y″:1828,
  ″x″:-875,
}]
```

markerdelete

Delete an existing location marker.

### Example

```
// server <-- client
[client-id, ″he″, marker-id, ″markerdelete″,{ }]
// server --> client
[client-id, ″he″, marker-id, event-id, ″markerdelete″,{ }]
Alternative form accepted by browser client
// server <-- client
[client-id, ″he″, target-id, ″delete″,{
  ″hidden″ true,
}]
// server --> client
[client-id, ″he″, target-id, event-id, ″delete″,{
  ″hidden″:true,
}]
```

tsxappevent

TSXappevent sends a history event to various widgets on the tsx system.

### Example

```
// server <-- client
[client-id, ″he″, target-id, ″tsxappevent″,{
  ″payload″:
  {
    additional-properties
  },
  ″messageType″:message-type,
  ″targetTsxAppId″:tsx-app-id
}]
// server --> client
[client-id, ″he″, target-id, event-id, ″tsxappevent″,{
  ″payload″:
  {
    additional-properties
  },
  ″message Type″:message-type,
  ″targetTsxAppId″:tsx-app-id
}]
```

Props
payload (object) the properties necessary for this tsxappevent
messageType (string) the type of message

### Example of Creating a Web Browser

```
// server <-- client
[client-id,“he”,new-browser-id,“tsxappevent”,{
  “payload”: {
    “y”:709,
    “x”:1517,
    “worldSpaceWidth”:800,
    “worldSpaceHeight”:600,
    “windowSpaceWidth”:800,
    “windowSpaceHeight”:600,
    “version”:1,
    “url”:“http://www.google.com/”,
    “order”:735880
  },
  “messageType”:“createBrowser”,
  “targetTsxAppId”:“webbrowser”
}]
// server --> client
[client-id,“he”,new-browser-id, event-id, “tsxappevent”, {
  “payload”: {
    “y”:709,
    “x”:1517,
    “worldSpaceWidth”:800,
    “worldSpaceHeight”:600,
    “windowSpaceWidth”:800,
    “windowSpaceHeight”:600,
    “version”:1,
    “url”:“http://www.google.com/”,
    “order”:735880
  },
  “messageType”:“createBrowser”,
  “targetTsxAppId”:“webbrowser”
  }]
```

Props
payload (object) details needed for creating a browser
   x (number) the x location of the marker
   y (number) the y location of the marker
   worldSpaceWidth (number) the width in world space
   worldSpaceHeight (number) the height in world space
   windowSpaceWidth (number) the width in window space
   windowSpaceHeight (number) the height in window space
   version (number) #TODO
   url (number) the url this browser widget should point to messageType *(string) “createBrowser” for creating browsers targetTsxAppId *(string) “webbrowser” for web browser widgets

### Example of Deleting a Web Browser

```
// client --> server
[client-id,″he″,target-id,″tsxappevent″,{
  ″messageType″:″deleteBrowser″,
  ″targetTsxAppId″:″webbrowser″,
  ″payload″:{version″:1}
}]
```

### Navigate

Example of navigating to different item in the payload. One could use this for example for a browser widget navigating to an URL

[
client-id,
″he″
target-id, //Group/presentation or maybe Browser URL ID
″navigate″,
payload // navigate to this page
]

11) ve Volatile Event

Volatile events are not recorded in the database, so they are good for in-progress streaming events like dragging a card around the screen, and once the user lifts their finger, a HistoryEvent is used to record its final place.

### Volatile Event Basic Message Format

//server <- ->client
[client-id, “ve”, target-id, event-type, event-properties]
client-id (string) the ID of the originating client
target-id (string) the ID of the target window to which this event is relevant
event-type (string) an arbitrary event type
properties (object) a JSON object describing pertinent key/values for the event

### Current Volatile Event Types

sb Begins a new stroke.
sc Continues a previously started stroke.
se Ends a stroke
position Used to share a position with other clients that should not be persisted. For example show a window being dragged in real time.
bf Begin Follow: User A begins to follow User B. Used to notify User A that user B is following.
of End Follow: User B is no longer following user A. Used to notify user A that user B is no longer following.

### Volatile Events by Widget Type

| | card | image | Workspace |
|---|---|---|---|
| sb | X | X | X |
| sc | X | X | X |
| se | X | X | X |
| position | X | X | |
| bf | | | X |
| ef | | | X |

Workspace
sb Starts a stroke. Used to render strokes on one client while they are being drawn on another client.
sc Continues a previously started stroke by giving another point to include. Used to render strokes while they are being drawn on another client.
se Ends a previously started stroke.
bf Begin Follow: User A begins to follow User B. Used to notify User A that user B is following.
of End Follow: User B is no longer following user A. Used to notify user A that user B is no longer following.

### Note

position Live updates the position of a note while its being moved by another user.
sb Starts a stroke. Used to render strokes on one client while they are being drawn on another client.
sc Continues a previously started stroke by giving another point to include. Used to render strokes while they are being drawn on another client.
se Ends a previously started stroke.

### Image

position Live updates the position of an image while its being moved by another user.
sb Starts a stroke. Used to render strokes on one client while they are being drawn on another client.
sc Continues a previously started stroke by giving another point to include. Used to render strokes while they are being drawn on another client.
se Ends a previously started stroke.

### Volatile Event Details

The following fields are properties of several volatile events.
stroke-id Stroke-IDs are selected by the client. Currently they are the sender-id composed with an increasing integer, separated by a dot. This is to make it unique within the server context among all clients.
target-id A stroke may be attached to a specific target (container) in the workspace. In the case of a stroke belonging to a widget, the target ID field would contain the ID of the widget. Strokes destined for the main canvas in the workspace are designated by having their target ID be the same as the workspace id.

### Position—ve

Used to broadcast intermediate steps of a window moving around the workspace.

### Generic Position Example

// server <--> client
[client-id, ″ve″, target-id, ″position″, {position-info}]

Props
position-info—information about the widget's new position

### Window Position Example

// server <--> client
[client-id, ″ve″, target-id, ″position″, {″rect″:[-1298,-390,-1018,-230],
″order″:4}]

Props
rect (object) the location of the target window
order (int) the z-order of the target window
   sb

Used to broadcast the beginning of a stroke to the other clients.

```
// server <--> client
[client-id, ″ve″, target-id, ″sb″,{
  ″brush″:1,
  ″size″:2,
  ″color″:[214,0,17,1],
  ″x″:100,
  ″y″:300,
  ″strokeId″:″395523d316e942b496a2c8a6fe5f2cac″
}]
```

Props
x,y (int) the starting point of this stroke
strokeId (string) the ID of the new stroke
   sc:

Continues the stroke specified by the stroke id.

// server <--> client
[client-id, ″ve″, target-id, ″sc″, {″x″:100, ″y″:300,
″strokeId″:″395523d316e942b496a2c8a6fe5f2cac″}]

Props
x,y (int) the new end-point of the stroke
strokeId (string) the ID of the new stroke
   se:

Ends the stroke specified by stroke-id.

// server <--> client
[client-id, ″ve″, target-id, ″se″, {″strokeId″:
″395523d316e942b496a2c8a6fe5f2cac″}]

stroke-id (string) the ID of the continued stroke

bf:

Begin Follow: User A begins to follow User B. Used to notify User A that user B is following. For this global volatile event, the target ID is the session id. The user being followed will update the UI to indicate that user B is following.

// server <--> client
[follower-client-id, ″ve″, session-id, ″bf″,
{″clientId″:″395523d316e942b496a2c8a6fe5f2cac″}]

Props
clientId (string) the ID of the client being followed
   ef:

End Follow: User B is no longer following user A. Used to notify user A that user B is no longer following. For this global volatile event, the target ID is the session id. The user being followed will update the UI to indicate that user B is no longer following. If user B leaves the session, user A will receive a room list message which does not contain user B. User A's room list will then be rebuilt, no longer showing user B as a follower.

// server <--> client
[follower-client-id, ″ve″, session-id, ″ef″,
{″clientId″:″395523d316e942b496a2c8a6fe5f2cac″}]

Props
clientId (string) the ID of the client no longer being followed

### Example Interaction: Moving Objects

A good example illustrating some of the HistoryEvent/VolatileEvent-related changes is moving an object. While the object is being moved/resized by dragging, a series of volatile events (VEs) is sent to the server, and re-broadcast to all clients subscribed to the workspace:

```
// client sends the following volatile events during the move
// client->server format is: [<clientId>, <messageType>, <targetId>,
    <eventType>, <messageProperties>]
[″511d6d429b4aee0000000003″,″ve″,″511d619c9b4aee0000000039″,
″position″,{
  ″rect″:[-493,73,-2,565],
  ″order″:0
}]
[″511d6d429b4aee0000000003″,″ve″,″511d619c9b4aee0000000039″,
″position″,{
  ″rect″:[-493,73,-2,565],
  ″order″:0
}]
[″511d6d429b4aee0000000003″,″ve″,″511d619c9b4aee0000000039″,
″position″,{
  ″rect″:[-538,91,-47,583],
  ″order″:0
}]
[″511d6d429b4aee0000000003″,″ve″,″511d619c9b4aee0000000039″,
″position″,{
  ″rect″:[-538,91,-47,583],
  ″order″:0
}]
```

Once the user finishes moving the object, the client should send a history event is sent to specify the rect and order of the object:

```
[″511d6d429b4aee0000000003″,″he″,″511d619c9b4aee0000000039″,
″position″,{
  ″rect″:[-492,73,-1,565],
  ″order″:0
}]
```

The server will respond with the newly persisted he record. Note the inclusion of the record's eventId.

```
// server-> client format of ′he′ is: [<clientId>, <messageType>,
<targetId>, <eventId>,
//  <eventType>, <messageProps>]
[″511d6d429b4aee0000000003″,″he″,″511d6f9c9b4aee0000000039″,
    ″511d9165c422330000000253″,″position″,{
  ″rect″:[-492,73,-1,565],
  ″order″:0
}]
```

Note: The eventId will also be included in history that is fetched via the HTTP API.

Resizing a group would result in the generation of an “he” record showing a “rect” of a different dimension. For example, to double the size of a group within a workspace, an initial record of:

[″<clientId>″ ,″he″,″<targetId>″,″<eventId>″,″position″,{″rect″:
[0,0,1,1], ″order″:0}];
could be changed to:
[″<clientId>″,″he″,″<targetId>″,″<eventId>″,″position″,{″rect″:
[0,0,2,2], ″order″:0}]

12) disconnect Disconnect

Inform other app instances opened by the same user to close their connection and cease reconnect attempts. This is consumed by browser clients in order to prevent the “frantic reconnect” problem seen when two tabs are opened with the same workspace.

// server --> client
[-1, ″disconnect″]

13) Is List Streams

Inform a client of the current streams in a list. Triggered by other events, similar to a room list.

// server --> client
[send-id, ″ls″, [Stream List for Session]]

sender-id always −1 (indicating the server initiated the message)
   Stream list is an array of objects, each of which contains the following fields:
sessionId (string) is the id of the workspace containing the conference
conferenceId (string) the id of the conference session all users in this workspace connect to
clientId (Object ID) the ID of the client broadcasting this particular stream
streamId (string) the ID of this particular AV stream

14) bs Begin Stream

Informs the server of a new AV stream starting. The server responds with a List Streams message.

// server <-- client
[sender-id, ″bs″, conferenceId, conferenceProvider, streamId, streamType]

sender-id clientID of the user starting the stream
conferenceId (string) the id of the conference session all users in this workspace connect to
conferenceProvider (string) the type of conference, tokbox or twilio for exmple
streamId (string) the ID of this particular AV stream
streamType (string) audio, video or screenshare

15) es End Stream

Informs the server of a new AV stream ending. The server responds with a List Streams message.

// server <-- client
[sender-id, ″es″, conferenceId, streamId]

sender-id clientID of the user starting the stream
conferenceId (string) the id of the conference session all users in this workspace connect to
streamId (string) the ID of this particular AV stream

16) ss Stream State

Informs the server of an existing AV stream changing state. The server responds with a List Streams message.

// server <-- client
[sender-id, ″ss″, streamId, streamType]

sender-id clientID of the user starting the stream

streamId (string) the ID of this particular AV stream

streamType (string) audio, video or screenshare

17) oid Object ID Reservation

Use this to create a new unique object id that is acceptable for creating new history events which create an object.

′″javascript

// server <-- client
[sender-id, ″oid″]

Server responds with:

// server --> client
[″-1″, ′oid′, <new-object-id>]

The API described above provides one example message structure. Other structures may be utilized as well, as suits a particular implementation.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “indicate” is used herein to mean the same as “identify”.

Also, as used herein, a given signal, event or value is “responsive” to a predecessor signal, event or value if the predecessor signal, event or value influenced the given signal, event or value. If there is an intervening processing element, step or time period, the given signal, event or value can still be “responsive” to the predecessor signal, event or value. If the intervening processing element or step combines more than one signal, event or value, the signal output of the processing element or step is considered “responsive” to each of the signal, event or value inputs. If the given signal, event or value is the same as the predecessor signal, event or value, this is merely a degenerate case in which the given signal, event or value is still considered to be “responsive” to the predecessor signal, event or value. “Dependency” of a given signal, event or value upon another signal, event or value is defined similarly.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the technology disclosed may consist of any such feature or combination of features. In view of the foregoing description it will be evident to a person skilled in the art that various modifications may be made within the scope of the technology disclosed.

The foregoing description of preferred embodiments of the technology disclosed has been provided for the purposes of illustration and description. It is not intended to be exhaustive or to limit the technology disclosed to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology disclosed. In addition, any and all variations described, suggested or incorporated by reference herein with respect to any one embodiment are also to be considered taught with respect to all other embodiments. The embodiments described herein were chosen and described in order to best explain the principles of the technology disclosed and its practical application, thereby enabling others skilled in the art to understand the technology disclosed for various embodiments and with various modifications as are suited to the particular use contemplated. It is intended that the scope of the technology disclosed be defined by the following claims and their equivalents.

As with all flowcharts herein, it will be appreciated that many of the steps can be combined, performed in parallel or performed in a different sequence without affecting the functions achieved. In some cases, as the reader will appreciate, a rearrangement of steps will achieve the same results only if certain other changes are made as well. In other cases, as the reader will appreciate, a rearrangement of steps will achieve the same results only if certain conditions are satisfied. Furthermore, it will be appreciated that the flow charts herein show only steps that are pertinent to an understanding of the technology disclosed, and it will be understood that numerous additional steps for accomplishing other functions can be performed before, after and between those shown.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the technology disclosed and the scope of the following claims. It is contemplated that technologies described herein can be implemented using collaboration data structures other that the spatial event map.

What is claimed is:

1. A system comprising a network node including a display having a physical display space, a user input device, a processor and a communication port, the network node being configured with logic to:
establish communication with one or more other network nodes;
store at least part of a log of events relating to graphical targets having locations in a virtual workspace, entries in the log including a location in the virtual workspace of the graphical target of an event, a time of the event, and a target identifier of the graphical target;
map a screen space in the physical display space to a viewport within the virtual workspace to identify entries in the log within the viewport and render graphical targets identified by the identified entries onto the screen space;
accept input data from the user input device creating events that identify a group of graphical targets on the screen space; and
send messages identifying members of the identified group to the one or more other network nodes.

2. The system of claim 1, including logic to send messages identifying changes in the membership of the identified group.

3. The system of claim 1, wherein the logic to accept input data includes logic to interpret touch gestures in the screen space, including touch gestures to identify a plurality of graphical constructs as members of a group, and logic to render identifying graphical constructs in the screen space to indicate membership in the group by particular graphical constructs.

4. The system of claim 1, wherein the logic to accept input data includes logic to detect four simultaneous touch events in the screen space, and to interpret the four simultaneous touch events to define a boundary in the screen space for a selected group.

5. The system of claim 4, wherein the logic to interpret the four simultaneous touch events executes a process including:
selecting locations of two touch points in the four simultaneous touch events as a first pair and identifying two other touch points in the four simultaneous touch events as a second pair;
defining a first horizontal coordinate and a first vertical coordinate using the first pair and defining a second horizontal coordinate and a second vertical coordinate using the second pair;
identifying graphical constructs using a polygon defined by the first horizontal coordinate, the first vertical coordinate, the second horizontal coordinate and the second vertical coordinate;
upon detection of a selection-end event, identifying a group including the identified graphical targets as members of the group; and
sending the message identifying the members of the identified group.

6. A method of creating a group of objects by a collaborator in a collaborative workspace using a collaboration system, the collaboration system comprising a network node including a display having a physical display space, a user input device, a processor and a communication port, the method comprising:
establishing communication with one or more other network nodes using the communication port;
storing at least part of a log of events relating to graphical targets having locations in a virtual workspace, entries in the log including a location in the virtual workspace of the graphical target of an event, a time of the event, and a target identifier of the graphical target;
mapping a screen space in the physical display space to a viewport within the virtual workspace, to identify entries in the log within the viewport, render graphical targets identified by the identified entries onto the screen space;
accepting input data from the user input device creating events that identify a group of graphical targets on the screen space; and
sending messages identifying members of the identified group to the one or more other network nodes.

7. The method of claim 6, including sending messages identifying changes in the members of the identified group.

8. The method of claim 6, further comprising:
interpreting an input as a gesture indicating movement of a graphical target within the identified group;
moving the identified group in the screen space; and
sending a message indicating movement of the identified group to the one or more other network nodes.

9. The method of claim 6, further comprising:
interpreting an input as a gesture indicating resizing of a graphical target within the identified group;
resizing the identified group in the screen space; and
sending messages indicating resizing of the identified group to the one or more other network nodes.

10. The method of claim 6, further comprising:
interpreting an input as a gesture indicating deletion of a graphical target within the identified group;
deleting the identified group in the screen space; and
sending messages indicating deletion of the identified group to the one or more other network nodes.

11. The method of claim 6, further comprising:
interpreting an input as a gesture indicating removal of a graphical target within the identified group;
removing the identified graphical target from the identified group; and
sending messages indicating removal of the identified graphical target to the one or more other network nodes.

12. The method of claim 6, further comprising:
interpreting an input as a gesture indicating addition of a graphical target to the identified group;
adding the identified target to the identified group; and
sending messages indicating addition of the identified graphical target to the one or more other network nodes.

13. The method of claim 6, further comprising:
interpreting an input as a gesture indicating duplication of a graphical target within the identified group; and
for each member of the identified group:
duplicating the member of the identified group; and
sending messages indicating duplication of the member to the one or more other network nodes.

14. The method of claim 6, further comprising:
interpreting an input as a gesture indicating an ungrouping of an identified group;
removing the members from the identified group; and
sending a message indicating a group with no members to the one or more other network nodes.

15. A system comprising a network node including a display having a physical display space, a user input device, a processor and a communication port, the network node being configured with logic to:
establish communication with one or more other network nodes;
store at least part of a workspace collaboration data structure including graphical objects having locations in a virtual workspace, entries in the data structure including a location in the virtual workspace of the graphical objects;
map a screen space in the physical display space to a viewport within the virtual workspace, to identify entries in the data structure within the viewport, render graphical objects identified by the identified entries onto the screen space;
identify groups of objects in the data structure;
accept input data from the user input device and determine whether the input relates to identifying members in a group, and apply group rules for interpreting the input; and
send messages identifying the members of the group to the one or more other network nodes.

16. The system of claim 15, wherein the data structure comprises a log of events relating to graphical targets having locations in a virtual workspace, entries in the log including a location in the virtual workspace of the graphical target of an event, a time of the event, and a target identifier of the graphical target.

17. A system comprising:
a network node including a display having a physical display space, a user input device, a processor and a communication port, the network node being configured with logic to:
establish communication with one or more other network nodes;
store at least part of a workspace collaboration data structure including graphical objects having locations in a virtual workspace, entries in the data structure including a location in the virtual workspace of the graphical objects;
map a screen space in the physical display space to a viewport within the virtual workspace, to identify entries in the data structure within the viewport, and render graphical objects identified by the identified entries onto the screen space;
identify groups of objects in the data structure; and
receive messages from other nodes and determine whether the messages relate to members in a group, and apply group rules for interpreting the message.

18. The system of claim 15, wherein the data structure comprises a log of events relating to graphical targets having locations in a virtual workspace, entries in the log including a location in the virtual workspace of the graphical target of an event, a time of the event, and a target identifier of the graphical target.

19. A system comprising:
a display having a physical display space, a user input device to detect touch gestures on the physical display space, and a processor, the processor including logic to interpret data detected in response to touch gestures in on the physical display space, including four simultaneous touch events, and to interpret the four simultaneous touch events to define a boundary in the screen space for a selected group.

20. The system of claim 19, wherein the logic to interpret the four simultaneous touch events executes a process including:
selecting locations of two touch points in the four simultaneous touch events as a first pair and identifying two other touch points in the four simultaneous touch events as a second pair;
defining a first horizontal coordinate and a first vertical coordinate using the first pair and defining a second horizontal coordinate and a second vertical coordinate using the second pair;
identifying graphical constructs using a polygon defined by the first horizontal coordinate, the first vertical coordinate, the second horizontal coordinate and the second vertical coordinate;
upon detection of a selection-end event, identifying a group including the identified graphical targets as members of the group; and
interpreting additional input associated with members of a group according to group rules.

21. The system of claim 19, the processor including logic to render identifying graphical constructs in the physical display space to indicate membership in the group by particular graphical constructs.
